(19) United States
(12) Patent Application Publication
(10) Pub. No.: US 2022/0067850 A1
(43) Pub. Date: Mar. 3, 2022

(54) SYSTEMS AND METHODS FOR MANAGING ENERGY STORAGE SYSTEMS

(71) Applicant: Electra Vehicles, Inc., Boston, MA (US)

(72) Inventors: Saurabh Bhasme, Allston, MA (US); Thomas James Couture, Huntington, VT (US); Britany Straley, Brookline, MA (US); Fabrizio Martini, Boston, MA (US)

(73) Assignee: Electra Vehicles, Inc., Boston, MA (US)

(21) Appl. No.: 17/275,430

(22) PCT Filed: Sep. 12, 2019
(86) PCT No.: PCT/US2019/050845

§ 371 Date: Mar. 11, 2021

Related U.S. Application Data
(60) Provisional application No. 62/867,180, filed on Jun. 26, 2019.
(60) Provisional application No. 62/730,434, filed on Sep. 12, 2018.

(51) Int. Cl. G06Q 50/06; G06Q 10/06; G05B 13/02

(52) U.S. Cl. CPC G06Q 50/06; G05B 13/0265; G06Q 10/06315

(57) ABSTRACT

Systems, methods, and at least one computer-readable medium are described. The system comprises at least one processor and at least one computer-readable storage medium having encoded thereon instructions that, when executed, program the at least one processor to for each candidate model of a plurality of candidate models, determine a reward for using the candidate model in a context, wherein the context comprises a value of a feature selected from a group consisting of, a feature relating to an environment in which an energy application is operating, a feature relating to the energy application, and a feature relating to one or more energy storage devices associated with the energy application. The at least one processor being further programmed to select a model from the plurality of candidate models, based at least in part on the respective rewards for using the candidate models in the context.

### RELATED APPLICATIONS

This application claims the benefit under 35 USC 119(e) of U.S. Provisional Application No. 62/730,434, entitled “SELF-LEARNING ADAPTIVE CONTROLS FOR PERFORMANCE ENHANCEMENTS OF ENERGY STORAGE SYSTEMS,” filed on Sep. 12, 2018, which is incorporated herein by reference in its entirety.

This application claims the benefit under 35 USC 119(e) of U.S. Provisional Application No. 62/867,180, entitled “SYSTEMS AND METHODS FOR MANAGING ENERGY STORAGE SYSTEMS,” filed on Jun. 26, 2019, which is incorporated herein by reference in its entirety.

This application may include subject matter related to that of International Application No. PCT/US2018/067385, filed on Dec. 21, 2018, entitled “SYSTEM AND METHOD FOR DESIGNING AND CONTROLLING A DUAL ENERGY STORAGE SYSTEM,” which is hereby incorporated by reference in its entirety.

### BACKGROUND

Energy generated or harvested at one point in time may be stored for use at a later point in time using many different types of energy storage devices, such as electrochemical batteries, supercapacitors, lithium capacitors, hydrogen fuel cells, compressed air energy storage, flywheel energy storage, etc. Energy storage devices based on different principles of operation may have different characteristics. For instance, some energy storage devices (e.g., electrochemical batteries) may be able to store large amounts of energy on a unit mass basis and/or a unit volume basis, whereas some energy storage devices (e.g., supercapacitors) may be able to deliver large amounts of power on a unit mass basis and/or a unit volume basis.

Often times, especially when there are constraints such as cost, weight, space, etc., it may be challenging to provide an energy storage device that is able both to store a large amount of energy and to deliver a large amount of power. For instance, design choices (e.g., battery chemistry, electrode configuration, etc.) that are made to achieve higher energy density (and/or specific energy) may lead to lower power density (and/or specific power), and vice versa.

Moreover, in case of an electrochemical battery, a high rate of discharge may produce excessive heat, which may damage the battery and shorten its usable life.

### SUMMARY

Some embodiments relate to a system, method, and at least one computer-readable medium. The system comprises at least one processor and at least one computer-readable storage medium having encoded thereon instructions that, when executed, program the at least one processor to for each candidate model of a plurality of candidate models, determine a reward for using the candidate model in a context, wherein the context comprises a value of a feature selected from a group consisting of, a feature relating to an environment in which an energy application is operating, a feature relating to the energy application, and a feature relating to one or more energy storage devices associated with the energy application. The at least one processor being further programmed to select a model from the plurality of candidate models, based at least in part on the respective rewards for using the candidate models in the context.

In one aspect, the context comprises a current context, the at least one processor is programmed to select a model from the plurality of candidate models in response to detecting a change from a prior context to the current context, and the at least one processor is further programmed to deploy the selected model for the energy application in the current context.

In one aspect, selecting a model from the plurality of candidate models comprises with a selected probability ∈: select a model from the plurality of candidate models uniformly at random; and with probability 1−∈: select a model from the plurality of candidate models that has a highest reward with respect to the context.

In one aspect, the reward for using a candidate model in the context is based on data collected from previously deploying the candidate model for the energy application in that context.

In one aspect, the reward for using a candidate model in the context is based on data collected from deploying the candidate model for a plurality of energy applications in that context.

In one aspect, the reward for using a candidate model in the context is based on data collected from performing simulation with the candidate model in that context.

In one aspect, each candidate model of the plurality of candidate models belongs to a model category, each candidate model of the plurality of candidate models has previously been deployed in the context, and the at least one processor is further programmed to determine whether the model category comprises one or more candidate models that have not been deployed in the context, and in response to determining that the model category comprises one or more candidate models that have not been deployed in the context, select a model from the one or more candidate models that have not been deployed in the context, and the at least one processor is programmed to select a model from the plurality of candidate models, which have previously been deployed in the context, in response to determining that the model category does not comprise any candidate model that has not been deployed in the context.

In one aspect, the at least one processor comprises a local processor associated with the energy application, the plurality of candidate models comprises a first plurality of candidate models, the local processor is programmed to: determine a reward for each candidate model of the first plurality of candidate models, and select a model from the first plurality of candidate models, based at least in part on the respective rewards, the at least one processor further comprises a remote processor associated with a plurality of energy applications, the remote processor is programmed to: determine a reward for each candidate model of a second plurality of candidate models, select a model from the second plurality of candidate models, based at least in part on the respective rewards, and transmit, to the local processor, an indication of the model selected by the remote processor.

In one aspect, the first plurality of candidate models, which is used by the local processor, is a subset of the second plurality of candidate models, which is used by the remote processor.

In one aspect, each candidate model of the plurality of candidate models comprises an energy management strategy that maps one or more inputs to a power distribution among the one or more energy storage devices associated with the energy application.

In one aspect, the plurality of candidate models comprises a first plurality of candidate models, the context comprises a first context, the feature comprises a first feature, the selected model comprises a first selected model, and the at least one processor is further programmed to: for each candidate model of a second plurality of candidate models, determine a reward for using the candidate model in a second context, wherein the second context comprises a value of a second feature different from the first feature, and select a second model from the second plurality of candidate models, based at least in part on the respective rewards for using the candidate models in the second context.

In one aspect, for each candidate model of the second plurality of candidate models: the candidate model comprises an estimation model that maps one or more inputs to an estimated value of a parameter, and the reward for using the candidate model in the second context is based on accuracy of the estimation model when deployed in the second context.

In one aspect, the at least one processor is further programmed to: apply the selected second model to obtain an estimated value of the parameter, and apply the selected first model to the estimated value of the parameter and/or one or more other inputs to obtain a power distribution among the one or more energy storage devices associated with the energy application.

In one aspect, each candidate model of the plurality of candidate models comprises an energy storage device model that maps one or more inputs to an output relating to an energy storage device associated with the energy application.

In one aspect, each candidate model of the plurality of candidate models comprises an energy application model that maps one or more inputs to an output relating to the energy application.

In one aspect, each candidate model of the plurality of candidate models comprises an environment model that maps one or more inputs to an output relating to the environment in which the energy application is operating.

In one aspect, the energy application comprises an electric vehicle or an electric grid. Some embodiments relate to a system, method, and at least one computer-readable medium. The system, comprises at least one computer processor, and at least one computer-readable storage medium having encoded thereon instructions that, when executed, program the at least one processor to: estimate a value of a parameter for an energy application using a plurality of machine learning models including a first machine learning model and a second machine learning model, wherein the second machine learning model is configured to receive as input, at least one output of the first machine learning model, and the value of the parameter is estimated, at least in part, based on an output of the second machine learning model.

In one aspect, the energy parameter comprises a total power demand for the energy application.

In one aspect, the energy application comprises an electric vehicle.

In one aspect, the plurality of machine learning models further includes a third machine learning model, and the second machine learning model is further configured to receive as input, at least one output of the third machine learning model.

In one aspect, the plurality of machine learning models further includes a fourth machine learning model, and the second machine learning model is further configured to receive as input, at least one output of the fourth machine learning model.

In one aspect, the first machine learning model is trained to output an estimated state of charge of an energy storage device associated with the energy application, the third machine learning model is trained to output an estimated velocity profile associated with the energy application, the fourth machine learning model is trained to output an estimated climate control power demand associated with the energy application, and the second machine learning model is trained to output a total power demand for the energy application based, at least in part, on the estimated state of charge, the estimated velocity profile, and the estimated climate control power demand provided as input to the second machine learning model.

In one aspect, the at least one output of first machine learning model comprises an estimate selected from the group consisting of a state of charge, a velocity profile, and a climate control power demand, the output of the second machine learning model comprises a total power demand for the energy application, and the second machine learning model is trained to output the total power demand based, at least in part, on the estimate output from the first machine learning model.

In one aspect, one or more of the plurality of machine learning models includes an artificial neural network.

In one aspect, the artificial neural network includes at least one hidden layer.

In one aspect, at least one of the plurality of machine learning models is configured to receive one or more input values during operation of the energy application.

### BRIEF DESCRIPTION OF DRAWINGS

FIG. 1A shows an illustrative energy storage management system 100, in accordance with some embodiments.

FIG. 1B shows an illustrative remote energy storage management system 150 and an illustrative local energy storage management system 160, in accordance with some embodiments.

FIG. 2A shows an illustrative machine learning model 200, in accordance with some embodiments.

FIG. 2B shows an illustrative set 250 of machine learning models, in accordance with some embodiments.

FIG. 3 shows an illustrative simulation engine 300, in accordance with some embodiments.

FIG. 4 shows an illustrative process 400 for analyzing energy management strategies, in accordance with some embodiments.

FIG. 5 shows an illustrative decision graph 500, in accordance with some embodiments.

FIG. 6 shows an illustrative network 600 of model categories, in accordance with some embodiments.

FIG. 7 shows an illustrative process 700 for determining a velocity profile for a travel path, in accordance with some embodiments.

FIG. 8 shows an illustrative system 1000 on which one or more aspects of the present disclosure may be implemented, in accordance with some embodiments.

### DETAILED DESCRIPTION

The inventors have recognized and appreciated that performance of an energy storage device may vary depending on one or more external conditions (e.g., temperature, humidity, barometric pressure, etc.) and/or one or more internal conditions (e.g., oxidation and/or buildup on electrodes). The one or more internal conditions may, in turn, depend on how the energy storage device has been used in the past. For instance, excessive heat and/or rapid discharge may cause damage to an electrochemical battery.

Accordingly, in some embodiments, techniques are provided for managing energy storage systems in an adaptive manner. For example, techniques may be provided for dynamically controlling charging and/or discharging of one or more energy storage devices, where control decisions may be made based on one or more external conditions and/or one or more internal conditions.

An external or internal condition of an energy storage device may be determined in any suitable manner. For instance, in some embodiments, an external or internal condition may be measured using one or more sensors. Additionally, or alternatively, an external or internal condition may be derived from sensor data and/or other data (e.g., historical data relating to how the energy storage device has been used in the past). For example, an external or internal condition may be predicted by applying one or more models to the sensor data and/or the other data.

In some embodiments, an energy storage system may be provided that includes two or more different types of energy storage devices. Such an energy storage system is sometimes referred to herein as a “heterogeneous” energy storage system. For instance, an energy storage device with a relatively high energy density (and/or specific energy) may be used to meet power demand that is relatively steady. When there is a spike in power demand, an energy storage device with a relatively high power density (and/or specific power) may be used in addition to, or instead of, the energy storage device with a relatively high energy density (and/or specific energy). However, it should be appreciated that aspects of the present disclosure are not limited to using a heterogeneous energy storage system. One or more of the techniques described herein may be used to manage and/or design an energy storage system having one or more energy storage devices of a same type. Such an energy storage system is sometimes referred to herein as a “homogeneous” energy storage system.

It should be appreciated that the techniques introduced above and discussed in greater detail below may be implemented in any of numerous ways, as the techniques are not limited to any particular manner of implementation. Examples of implementation details are provided herein solely for illustrative purposes. Furthermore, the techniques disclosed herein may be used individually or in any suitable combination, as aspects of the present disclosure are not limited to the use of any particular technique or combination of techniques.

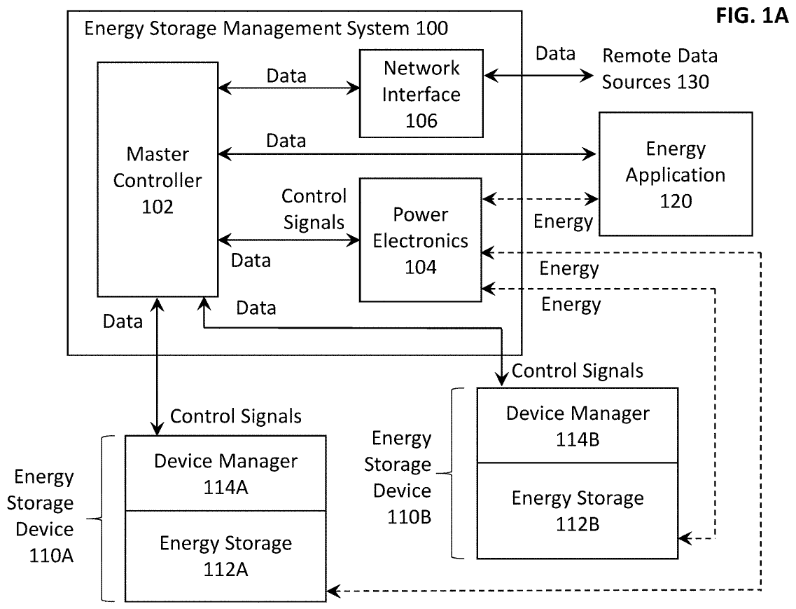

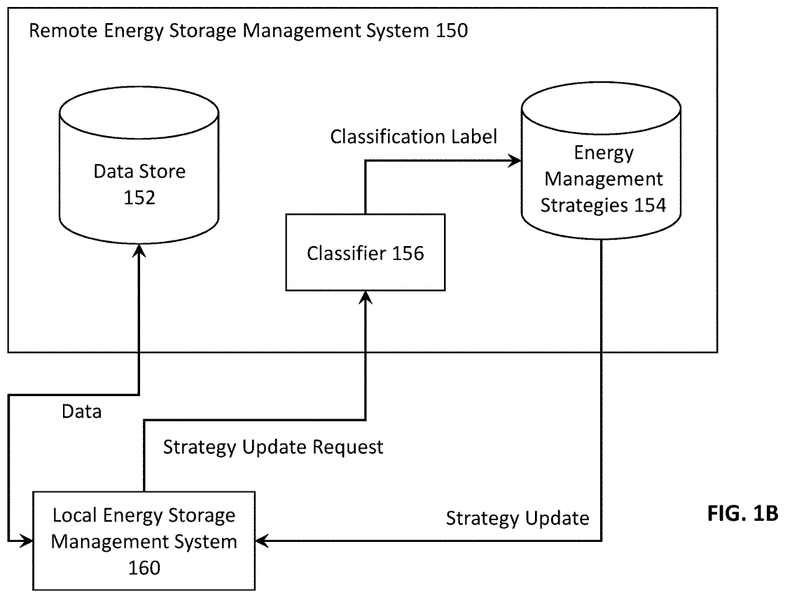

FIG. 1A shows an illustrative energy storage management system 100, in accordance with some embodiments. In this example, the illustrative energy storage management system 100 is used to manage energy storage devices 110A and 110B to supply energy to, and/or receive energy from, an energy application 120. The energy application 120 may be any suitable energy application, such as a vehicle, an appliance, a data center, an electric grid, etc. It should be appreciated that an energy application may fall within one or more of these categories. For instance, a warehouse robot may be both a vehicle and an appliance.

Examples of vehicles include, but are not limited to, land vehicles (e.g., cars, motorcycles, scooters, trams, etc.), watercrafts (e.g., boats, jet skis, hovercrafts, submarines, etc.), aircrafts (e.g., drones, helicopters, airplanes, etc.), and spacecrafts. It should be appreciated that a vehicle may fall within multiple ones of these categories. For instance, a seaplane may be both a watercraft and an aircraft.

Examples of appliances include, but are not limited to, robots, HVAC (heating, ventilation, and air conditioning) equipment, construction equipment, power tools, refrigeration equipment, and computing equipment. Such appliances may be used in any suitable setting, such as a residential setting, a commercial setting, and/or an industrial setting.

In some embodiments, the energy storage devices 110A and 110B may be of different types. For instance, the energy storage device 110A may have a higher energy density (and/or specific energy) compared to the energy storage device 110B. Additionally, or alternatively, the energy storage device 110B may have a higher power density (and/or specific power) compared to the energy storage device 110A. Accordingly, the energy storage device 110A and the energy storage device 110B are sometimes referred to herein as a “high energy” device and a “high power” device, respectively. Thus, it should be appreciated that the terms “high energy” and “high power” are used in a relative sense, as opposed to an absolute sense.

In the example shown in FIG. 1A, the energy storage device 110A includes an energy storage 112A, and the energy storage device 110B includes an energy storage 112B. In some embodiments, the energy storage 112A may include an electrochemical battery, whereas the storage 112B may include a supercapacitor. However, it should be appreciated that aspects of the present disclosure are not limited to using any particular energy storage technology or combination of energy storage technologies. In some embodiments, the energy storage 112A and 112B may both include electrochemical batteries, which may be of the same or different chemistry. In some embodiments, the energy storage 112A and 112B may both include supercapacitors, or other non-electrochemical energy storage units which may be of a same type or different types.

The energy storage 112A may be of any suitable construction. For instance, the energy storage 112A may use a liquid electrolyte, a solid electrolyte, and/or a polymer electrolyte. Moreover, the energy storage 112A may be a cell, a module, a pack, or another suitable unit that is individually controllable. Likewise, the energy storage 112B may be of any suitable construction, which may be the same as, or different from, the construction of the energy storage 112A. For instance, the energy storage 112B may use a liquid electrolyte, a solid electrolyte, and/or a polymer electrolyte. Moreover, the energy storage 112B may be a cell, a module, a pack, or another suitable unit that is individually controllable.

In some embodiments, one or both of the energy storage device 110A and the energy storage device 110B may include a device manager. For instance, in the example of FIG. 1A, the energy storage device 110A and the energy storage device 110B include, respectively, device managers 114A and 114B. For example, a device manager may include a battery management system (BMS) that is built into a smart battery pack.

In some embodiments, a device manager (e.g., the device manager 114A or the device manager 114B) may be configured to monitor one or more aspects of an associated energy storage (e.g., the energy storage 112A or the energy storage 112B). Examples of monitored aspects include, but are not limited to, current, voltage, temperature, state of charge (e.g., percentage charged), state of health (e.g., present capacity as a percentage of original capacity when the energy storage device was new), etc. For instance, the device manager may include one or more sensors configured to collect data from the associated energy storage. Additionally, or alternatively, the device manager may include one or more controllers configured to process data collected from the associated energy storage.

In some embodiments, a device manager (e.g., the device manager 114A or the device manager 114B) may be configured to control an associated energy storage (e.g., the energy storage 112A or the energy storage 112B). For instance, the device manager may be configured to stop discharging of the associated energy storage in response to determining that a temperature of the associated energy storage has reached a selected threshold. Additionally, or alternatively, in an embodiment in which the associated energy storage includes a plurality of cells in series, the device manager may be configured to perform balancing, for example, by transferring energy from a most charged cell to a least charged cell.

In some embodiments, a device manager (e.g., the device manager 114A or the device manager 114B) may be configured to transmit data via a communication interface, such as a bus interface (e.g., Controller Area Network, or CAN), a wireless interface (e.g., Bluetooth), etc. For instance, the device manager may be configured to transmit data to a master controller 102 of the energy storage management system 100. Any suitable data may be transmitted, including, but not limited to, sensor data and/or one or more results of analyzing sensor data.

It should be appreciated that aspects of the present disclosure are not limited to using an energy storage device with an associated device manager. In some embodiments, one or more sensors external to an energy storage device may be used to monitor one or more aspects of the energy storage device, such as current, voltage, temperature, state of charge (e.g., percentage charged), state of health (e.g., present capacity as a percentage of original capacity when the energy storage device was new), etc.

In some embodiments, the master controller 102 may receive data from the energy application 120 in addition to, or instead of, the device manager 114A and/or the device manager 114B. For instance, the energy application 120 may provide data indicating how much power the energy application 120 is currently drawing or supplying. Additionally, or alternatively, the energy application 120 may provide environmental data such as weather (e.g., temperature, humidity, atmospheric pressure, etc.), traffic (in case of a vehicle), etc. Additionally, or alternatively, the energy application 120 may provide operational data such as speed (in case of a vehicle), CPU usage (in case of computing equipment), load weight (in case of a warehouse robot or a drone), etc.

Additionally, or alternatively, the master controller 102 may receive data from power electronics 104, which may include circuitry configured to distribute a demand or supply of power by the energy application 120 between the energy storage devices 110A and 110B. For instance, the power electronics 104 may provide data indicating whether the energy application 120 is currently drawing or supplying power, how much power the energy application 120 is currently drawing or supplying, and/or how that power is distributed between the energy storage devices 110A and 110B.

Additionally, or alternatively, the master controller 102 may receive data from one or more remote data sources 130. For example, the energy storage management system 100 may include a network interface 106 configured to establish a connection using a suitable networking technology (e.g., 5G, WiMax, LTE, GSM, WiFi, Ethernet, Bluetooth, etc.). Although only one network interface is shown in FIG. 1A, it should be appreciated that aspects of the present disclosure are not so limited. In some embodiments, a plurality of network interfaces may be provided, which may be of the same type or different types. In some embodiments, no network interface may be provided, and the master controller 102 may receive data from a remote data source via the energy application 120.

Moreover, it should be appreciated that data may be received from any suitable remote data source. For instance, the energy application 120 may be a vehicle in a fleet of vehicles, and the master controller 102 may receive data from other vehicles in the fleet. Additionally, or alternatively, the master controller 102 may receive data from a cloud server that is monitoring and/or controlling the fleet.

In some embodiments, the master controller 102 may be configured to provide one or more control signals to the power electronics 104. For instance, the master controller 102 may be configured to analyze data received from the energy storage device 110A, the energy storage device 110B, the power electronics 104, the energy application 120, and/or the one or more remote data sources 130. Based on a result of the analysis, the master controller 102 may determine how a demand (or supply) of power by the energy application 120 should be distributed between the energy storage devices 110A and 110B, and/or whether energy should be transferred from the energy storage device 110A to the energy storage device 110B, or vice versa. The master controller 102 may then provide one or more control signals to the power electronics 104 to effectuate the desired distribution of power and/or energy.

Although details of implementation are described above and shown in FIG. 1A, it should be appreciated that aspects of the present disclosure are not limited to any particular manner of implementation. For instance, while two energy storage devices (i.e., 110A and 110B) are shown in FIG. 1A, it should be appreciated that aspects of the present disclosure are not limited to using any particular number of one or more energy storage devices. In some embodiments, just one energy storage device may be used, or three, four, five, etc. energy storage devices may be used.

FIG. 1B shows an illustrative remote energy storage management system 150 and an illustrative local energy storage management system 160, in accordance with some embodiments. For instance, the local energy storage management system 160 may include the illustrative energy storage management system 100 in the example of FIG. 1A, and may be co-located with the illustrative energy application 120. By contrast, the remote energy storage management system 150 may be located away from the energy application 120, and may communicate with the local energy storage management system 160 via one or more networks. For instance, the remote energy storage management system 150 may be located at a cloud server, and may communicate with one or more local energy storage management systems that are associated, respectively, with one or more energy applications (e.g., a fleet of electric vehicles).

The inventors have recognized and appreciated that a local energy storage management system may have one or more resource constraints, such as limited memory, limited processing cycles, etc. Accordingly, in some embodiments, the local energy storage management system 160 may transmit data to the remote energy storage management system 150 for storage and/or processing. For instance, the remote energy storage management system 150 may include a data store 152, which may store data received from the local energy storage management system 160 and/or one or more other local energy storage management systems. Accordingly, the local energy storage management system 160 may store a smaller amount of historical data, such as data collected from the energy application 120 over a shorter period of time (e.g., past hour, day, week, etc.), whereas the remote energy storage management system 150 may store a larger amount of historical data, such as data collected from the energy application 120 over a longer period of time (e.g., past month, quarter, year, etc.).

The inventors have further recognized and appreciated that a local energy storage management system may have access to limited data. For instance, the local energy storage management system 160 may have access only to data collected from the energy application 120. Accordingly, in some embodiments, the local energy storage management system 160 may receive data from the remote energy storage management system 150. Any suitable data may be received from the remote energy storage management system 150, including, but not limited to, traffic data, weather data, and/or data collected from one or more other energy applications.

The local energy storage management system 160 may transmit data to, and/or receive data from, the remote energy storage management system 150 in any suitable manner. In some embodiments, the local energy storage management system 160 may transmit data to, and/or receive data from, the remote energy storage management system 150 in real time. For instance, the local energy storage management system 160 may use one or more wired and/or wireless networking technologies to transmit data to, and/or receive data from, the remote energy storage management system 150 periodically (e.g., every second, minute, five minutes, 10 minutes, etc.). Additionally, or alternatively, the local energy storage management system 160 may transmit data to, and/or receive data from, the remote energy storage management system 150 in a batched fashion. For instance, the energy application 120 may include an electric vehicle, and the local energy storage management system 160 may transmit data to, and/or receive data from, the remote energy storage management system 150 when the energy application 120 is charging at a station.

In some embodiments, the local energy storage management system 160 may use one or more energy management strategies to analyze one or more inputs and output one or more control signals. The one or more energy management strategies may be selected dynamically. For instance, with reference to the example of FIG. 1A, an energy management strategy may be selected based on one or more conditions relating to the illustrative energy storage devices 110A-B and/or the illustrative energy application 120, and/or one or more environmental conditions.

Since the local energy storage management system 160 may have limited memory and/or processing cycles, the remote energy storage management system 150 may, in some embodiments, assist the local energy storage management system 160 in storing and/or selecting an appropriate energy management strategy. For instance, the remote energy storage management system 150 may store a collection of energy management strategies 154. Additionally, or alternatively, the remote energy storage management system 150 may include a classifier 156 configured to perform classification based on data received from the local energy storage management system 160.

In some embodiments, the local energy storage management system 160 may be configured to detect a change in one or more relevant conditions. As an example, the energy application 120 may include an electric vehicle, and the local energy storage management system 160 may be configured to detect a change in road conditions, for instance, by comparing one or more sensor measurements (e.g., slip coefficient, wheel vibration, etc.) against one or more respective thresholds. In response to detecting a change in road condition, the local energy storage management system 160 may send, to the remote energy storage management system 150, a request for an energy management strategy update.

In some embodiments, the strategy update request sent by the local energy storage management system 160 may include pertinent data, such as the one or more sensor measurements that triggered the strategy update request. The remote energy storage management system 150 may use this data to select an appropriate energy management strategy. For instance, the classifier 156 may include a machine learning model that maps two inputs, slip coefficient and wheel vibration, to a label indicative of a type of road condition (e.g., paving blocks, asphalt, concrete, dirt, etc.). The classifier 156 may apply such a machine learning model to the data received from the local energy storage management system 160. The remote energy storage management system 150 may use a label output by the classifier 156 to select an appropriate energy management strategy from the collection of energy management strategies 154. The remote energy storage management system 150 may then return the selected energy management strategy to the local energy storage management system 160.

Any suitable technique may be used to train a machine learning model for the classifier 156. For instance, in some embodiments, the machine learning model may include an artificial neural network. Labeled data (e.g., slip coefficient and wheel vibration measurements under known road conditions) may be used to train the artificial neural network. Additionally, or alternatively, an unsupervised learning technique (e.g., cluster analysis) may be used. However, it should be appreciated that aspects of the present disclosure are not limited to using a machine learning model to select an appropriate energy management strategy.

Although details of implementation are described above and shown in FIG. 1B, it should be appreciated that aspects of the present disclosure are not limited to any particular manner of implementation. For instance, in some embodiments, multiple classifiers may be provided (e.g., for road conditions, traffic, weather, etc.). Appropriate program logic may be applied to the outputs of these classifiers to select an energy management strategy. Additionally, or alternatively, a classifier may be provided at the local energy storage management system 160, and a classifier output may be sent to the remote energy storage management system 150 instead of, or in addition to, one or more raw measurements.

In some embodiments, the local energy storage management system 160 of the energy application 120 may share data with an energy storage management system of another energy application. For instance, the local energy storage management system 160 may receive data from, and/or send data to, the other energy storage management system through a communication channel established using one or more suitable networking technologies (e.g., 5G, WiMax, LTE, GSM, WiFi, Ethernet, Bluetooth, etc.).

In some embodiments, the local energy storage management system 160 may receive, from an energy storage management system of another energy application, data that may be used to evaluate system performance and/or predict future power demand. Examples of such data include, but are not limited to, current traffic conditions, cycle efficiencies, and/or states of health of energy storage devices. The local energy storage management system 160 may analyze the received data and decide whether to replace a currently deployed energy management strategy with another energy management strategy. For instance, the local energy storage management system 160 may determine that the other energy application is experiencing environmental conditions that is similar to what the energy application 120 is likely to experience in the near future (e.g., upcoming traffic conditions), and the other energy application is performing well in those environmental conditions (e.g., cycle efficiencies and/or states of health above respective thresholds). Accordingly, the local energy storage management system 160 may decide to switch to an energy management strategy applied by the other energy application.

It should be appreciated that the local energy storage management system 160 may communicate with the other energy storage management system either directly or indirectly. For instance, the energy storage management systems may establish a direct communication channel. Additionally, or alternatively, the energy storage management systems may communicate through one or more intermediaries, such as the remote energy storage management system 150 in the example of FIG. 1B. For instance, the remote energy storage management system 150 may collect data from multiple energy applications (e.g., a fleet of vehicles), determine which energy applications are performing well and which are performing poorly, and decide whether to instruct a poor-performing energy application to switch an energy management strategy used by a well-performing energy application.

It should be appreciated that aspects of the present disclosure are not limited to having both a remote energy storage management system and a local energy storage management system. In some embodiments, there may be only a local energy storage management system, only a remote energy storage management system, or neither.

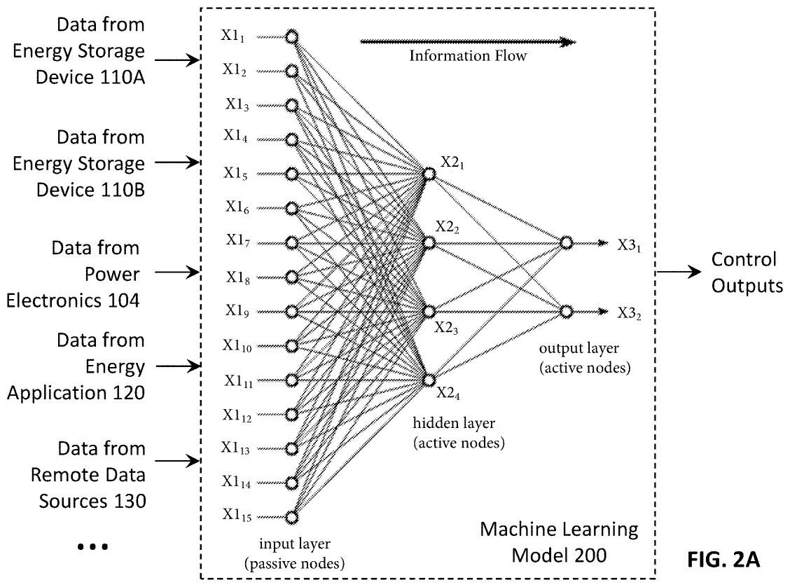

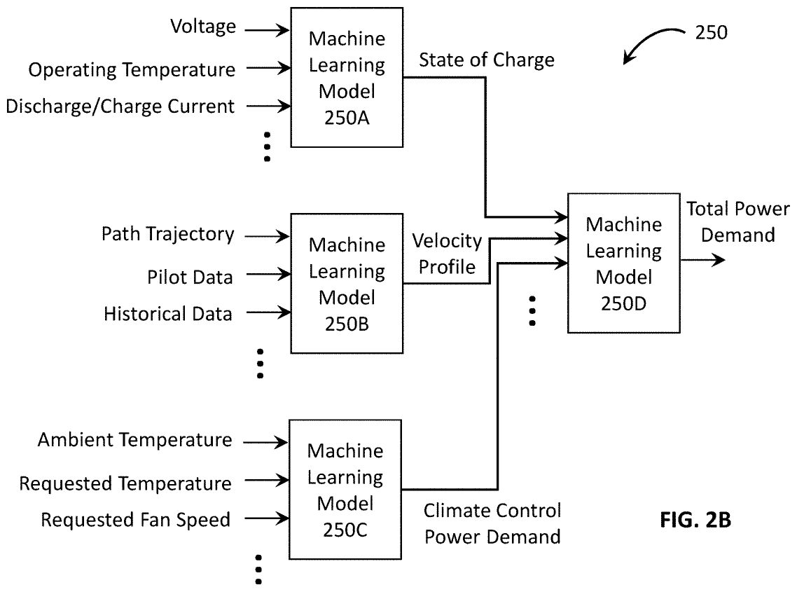

FIG. 2A shows an illustrative machine learning model 200, in accordance with some embodiments. The machine learning model 200 may be an energy management strategy that maps one or more inputs to one or more control outputs. (By contrast, the illustrative classifier 156 in the example of FIG. 1B may use a machine learning model that outputs one or more classification labels.)

In some embodiments, the machine learning model 200 may be part of the illustrative collection of energy management strategies 154 in the example of FIG. 1B. Additionally, or alternatively, the machine learning model 200 may be used by the illustrative master controller 102 in the example of FIG. 1A to analyze one or more inputs and output one or more control signals.

In some embodiments, the one or more inputs of the machine learning model 200 may include data from the illustrative energy storage device 110A, the illustrative energy storage device 110B, the illustrative power electronics 104, the illustrative energy application 120, and/or the one or more illustrative remote data sources 130 in the example of FIG. 1A. Such data may be received dynamically. The master controller 102 may use the machine learning model 200 to analyze the received data and provide one or more control signals accordingly. For instance, the master controller 102 may provide a control signal to the power electronics 104 to indicate how a demand or supply of power by the energy application 120 should be distributed between the energy storage devices 110A and 110B.

In some embodiments, the energy storage devices 110A and 110B may include one or more electrochemical battery packs, and the data received from the energy storage devices 110A and 110B may include one or more of the following. (The abbreviation “ESS” stands for energy storage system.)

TABLE 1
Data for Electrochemical Battery

| Dependent Variable | Symbol | Independent Variables | Symbol |
|---|---|---|---|
| Energy Storage System | SoC_{ESS} | Voltage | V_{ESS} |
| State of Charge | | Operating Temperature | T_{ESS} |
| | | Discharge/Charge Current | I_{ESS} |
| Equivalent Energy Storage | ESR_{ESS} | Discharge/Charge Current | I_{ESS} |
| System Series Resistance | | Operating Temperature | T_{ESS} |
| | | Energy Storage System State of | SoH_{ESS} |
| | | Health | |
| Energy Storage System | SoH_{ESS} | Energy Storage System Maximum | E_{ESS}_Nominal_Max |
| State of Health Estimate | | Nominal Capacity | |
| | | Energy Storage System Maximum | E_{ESS}_Max |
| | | Capacity^{l} | |
| | | Energy Storage Average State of | SOC_{ESS}_Average |
| | | Charge | |
| | | Number of Equivalent Full | N_{ESS} |
| | | Discharge Cycles | |
| | | Operating Temperature | T_{ESS} |

¹In some embodiments, maximum capacity for an energy storage device (e.g., battery, supercapacitor, etc.) may be modeled as a time-dependent function. For instance, maximum capacity may vary due to calendar aging, cyclical aging, etc. Additionally, or alternatively, a maximum capacity function may depend on one or more thermal conditions, one or more charge/discharge conditions, etc.

In some embodiments, the energy storage device 110B may include a supercapacitor, and the data received from the energy storage device 110B may include one or more of the following.

TABLE 2
Data for Supercapacitor

| Dependent Variable | Symbol | Independent Variables | Symbol |
|---|---|---|---|
| State of Charge | SOC_{ESS} | Voltage | V_{ESS} |
| | | Operating Temperature | T_{ESS} |
| | | Energy Storage System Capacitance | C_{ESS} |
| | | Discharge/Charge Current | I_{ESS} |
| Equivalent Energy Storage | ESR_{ESS} | Discharge/Charge Current | I_{ESS} |
| System Series Resistance | | Operating Temperature | T_{ESS} |
| | | Energy Storage System State of | SoH_{ESS} |
| | | Health | |
| Energy Storage System | SoH_{ESS} | Energy Storage System Maximum | E_{ESS}_Nominal_Max |
| State of Health Estimate | | Nominal Capacity | |
| | | Energy Storage System Maximum | E_{ESS}_Max |
| | | Capacity | |
| | | Energy Storage System Capacitance | C_{ESS} |
| | | Energy Storage Average State of | SOC_{ESS}_Average |
| | | Charge | |
| | | Number of Equivalent Full Discharge | N_{ESS} |
| | | Cycles | |
| | | Operating Temperature | T_{ESS} |

In some embodiments, the data received from the power electronics 104, the energy application 120, and/or the one or more remote data sources 130 may include general environmental data, such as one or more of the following.

TABLE 3A
General Environmental Data

| Data | Symbol | Unit |
|---|---|---|
| Temperature | T | C |
| Humidity | RH | % |
| Atmospheric Pressure | atm | Atm |
| Wind Speed and/or Direction | V_{wind} | m/s |

In some embodiments, the energy application 120 may include a vehicle, and the data received from the power electronics 104, the energy application 120, and/or the one or more remote data sources 130 may include vehicle environmental data, such as one or more of the following.

TABLE 3B
Vehicle Environmental Data

| Dependent Variable | Category | Independent Variables |
|---|---|---|
| Vehicle Projected | Path Trajectory | GPS Coordinates |
| Velocity Profile | | Road Slope |
| | | Speed Limit associated with Path Trajectory |
| | Sensor & Relational | Proximity to Co-Directional Vehicle(s) |
| | Data | Velocity of Co-Directional Vehicle(s) |
| | | Road Surface Classification |
| | Historical Data | Historical Path Trajectory Data associated with |
| | | Active Path Trajectory |
| Vehicle Projected | Climate Control | Ambient Temperature of Operating Environment |
| Auxiliary Power | Energy Demand | Absorption, Radiation and Transmission (ART) |
| Demand | | Ratio of Cabin² |
| | | Geospatial Insolation Angle |
| | Energy Storage | Ambient Temperature |
| | Active Thermal | |
| | Management | |

²In some embodiments, ART ratio may be modeled as a time-dependent function. For instance, ART ratio may vary due to aging of cabin glass, changing weather, etc. Additionally, or alternatively, ART ratio may vary

In some embodiments, one or more of the dependent variables and/or independent variables shown in Table 3B may be used to predict vehicle power demand.

In some embodiments, the energy application 120 may include an electric grid, and the data received from the power electronics 104, the energy application 120, and/or the one or more remote data sources 130 may include electric grid environmental data, such as one or more of the following.

TABLE 3C
Electric Grid Environmental Data

| Dependent Variable | Category | Independent Variables |
|---|---|---|
| Power Generation Forecast | Weather | Wind Speed [m/s] |
| | | Air Density [atm] |
| | | Solar Radiation [kW/m²] |

In some embodiments, one or more of the dependent variables and/or independent variables shown in Table 3C may be used to predict power generation (e.g., by wind turbines and/or solar panels) and/or power demand.

In some embodiments, the data received from the power electronics 104, the energy application 120, and/or the one or more remote data sources 130 may include general operational data, such as one or more of the following.

TABLE 4A
General Operational Data

| Data | Symbol | Unit |
|---|---|---|
| Power | P | kW |
| Current | i | Ampere |
| Energy efficiency | η | N/A |

depending on time of day, time of year, etc. Accordingly, ART ratio may have large fluctuations throughout useful life of a vehicle, but may have small fluctuations within a single drive cycle.

In some embodiments, the energy application 120 may include a vehicle, and the data received from the power electronics 104, the energy application 120, and/or the one or more remote data sources 130 may include vehicle operational data, such as one or more of the following.

TABLE 4B
Vehicle Operational Data

| Dependent Variable | Category | Independent Variables |
|---|---|---|
| Vehicle Projected | Pilot Data | Torque Demand |
| Velocity Profile | | Brake Position Sensor Data |
| | Historical Data | Historical Pilot Data associated with Active Path |
| | | Trajectory |
| | Vehicle Kinematics | Total Vehicle Chassis and Passenger/Payload |
| | | Mass |
| | | Road Load Coefficients (F₀, F₁, F₂) |
| | | Powertrain Efficiency |
| | | Regenerative Braking Efficiency |
| | | Power Electronics Efficiency |
| Vehicle Projected | Climate Control | Driver Requested Temperature |
| Auxiliary Power | Energy Demand | Driver Requested Fan Speed |
| Demand | | Cabin Window Position Sensor Data |
| | | Driver Requested Airflow Channel |
| | Transmission & | Transmission Rotational Velocity |
| | Powertrain Fluid | Transmission Oil Viscosity |
| | Pump Demand | Transmission Oil Temperature |
| | | Spin Loss |
| | Vehicle Operational | Brake-by-wire system power demand |
| | Losses | Steer-by-wire system power demand |
| | Energy Storage | Energy Storage System Heat Generation |
| | Active Thermal | Energy Storage System Operating Temperature |
| | Management | Range |
| | | Energy Storage System Measured Temperature |

In some embodiments, one or more of the dependent variables and/or independent variables shown in Table 4B may be used to predict vehicle power demand.

In some embodiments, the energy application 120 may include an electric grid, and the data received from the power electronics 104, the energy application 120, and/or the one or more remote data sources 130 may include electric grid operational data, such as one or more of the following.

TABLE 4C
Electric Grid Operational Data

| Dependent Variable | Category | Independent Variables |
|---|---|---|
| Power Generation Forecast | General | Generation Type (e.g., |
| | | Photovoltaic, Wind, etc.) |
| | | System Capacity |
| | | Power Electronics Losses |
| | | Transmission & Wiring |
| | | Losses |
| | Photovoltaic | Photovoltaic Panel Efficiency |
| | | Array Azimuth [°] |
| | | Array Tilt [°] |
| | Wind | Betz Limit [ ] |
| | | Blade Radius [m] |
| | | Tip Speed Ratio [ ] |
| Power Demand Forecast | Sensor & Historical Data | Forecast by Independent |
| | | System Operator (ISO) or |
| | | other Organization |
| | | Instantaneous Power Demand |
| | | Historical Power Demand |

In some embodiments, one or more of the dependent variables and/or independent variables shown in Table 3C may be used to predict power generation (e.g., by wind turbines and/or solar panels) and/or power demand.

It should be appreciated that the above examples of dynamic data are provided solely for purposes of illustration, as aspects of the present disclosure are not limited to using any particular type or combination of dynamic data, or any dynamic data at all. For instance, although vehicle and electric grid are discussed above, it should be appreciated that the techniques described herein may be used to manage energy storage systems for any type of energy application.

As described above in connection with the example of FIG. 1A, the master controller 102 may provide one or more control signals indicative of a power distribution. For instance, the one or more control signals may indicate a percentage of power to be drawn from, or supplied to, the energy storage device 110A, and/or a percentage of power to be drawn from, or supplied to, the energy storage device 110B. In some embodiments, this power distribution may be effectuated by the power electronics 104 during a next control cycle. Additionally, or alternatively, power distribution may be updated one or more times during a control cycle.

In some instances, power may be drawn from both the energy storage device 110A and the energy storage device 110B, and the one or more control signals may indicate how an overall power demand is split between these two energy storage devices. In some instances, power may be supplied to both the energy storage device 110A and the energy storage device 110B, and the one or more control signals may indicate how an overall power supply is split between these two energy storage devices.

In some embodiments, the master controller 102 may sometimes output a power distribution where a first amount of power is to be drawn from the energy storage device 110A, but a second amount of power is to be supplied to the energy storage device 110B. Additionally, or alternatively, the master controller 102 may sometimes output a power distribution where a first amount of power is to be supplied to the energy storage device 110A, but a second amount of power is to be drawn from the energy storage device 110B. A difference between the first amount and the second amount may indicate an amount of power drawn from, or supplied to, the energy application 120. If the energy application 120 is drawing power, the one or more control signals may indicate how an amount of power drawn from one energy storage device is split between the energy application 120 and the other energy storage device. If the energy application 120 is supplying power, the one or more control signals may indicate how an amount of power supplied to one energy storage device is split between the energy application 120 and the other energy storage device.

The inventors have recognized and appreciated that it may be desirable to provide updates in power distribution based on newly collected data. For instance, power distribution may be updated based on one or more objectives, such as improving lifetime of energy storage devices, improving energy efficiency (e.g., extending range of an electric vehicle), etc. Therefore, shorter control cycles may be beneficial. However, control cycles that are too short may lead to rapid power fluctuations, which may in turn cause damage to power electronics, electric motors, etc. Accordingly, in some embodiments, a duration of a control cycle may be selected that represents a desired tradeoff. For instance, a control cycle may last several seconds (e.g., 5 seconds, 10 seconds, 20 seconds, 30 seconds, 40 seconds, 50 seconds, 60 seconds, . . . ) or several minutes (e.g., 2 minutes, 3 minutes, 4 minutes, 5 minutes, 6 minutes, 7 minutes, 8 minutes, 9 minutes, 10 minutes, . . . ).

In some embodiments, data that is used by the master controller 102 to make control decisions may be acquired at a frequency that is the same as, or different from, a frequency at which power distribution is updated. For instance, a data acquisition frequency (e.g., every millisecond) may be a multiple of a power distribution update frequency (e.g., every second), so that multiple data points may be collected during a control cycle. A suitable statistic (e.g., mean, median, mode, maximum, minimum, etc.) of the data points may be used to determine an appropriate power distribution to be effectuated during a next control cycle.

In some embodiments, one or more machine learning techniques may be used to determine an appropriate power distribution. For instance, the machine learning model in the example of FIG. 2A may include an artificial neural network with an input layer, one or more hidden layers, and an output layer. In some embodiments, the artificial neural network may be a multilayer perceptron network, although that is not required. Aspects of the present disclosure are not limited to using any particular type of artificial neural network, or any artificial neural network at all.

The inventors have recognized and appreciated that, in some instances, it may be beneficial to use a set of machine learning models, as opposed to a single machine learning model. For instance, a machine learning model with a large number of input nodes may be replaced by a set of machine learning models each having a small number of input nodes. These machine learning models may be trained separately, thereby reducing computation complexity.

FIG. 2B shows an illustrative set 250 of machine learning models, in accordance with some embodiments. For instance, machine learning models 250A, 250B, 250C, 250D, . . . , collectively, may be used by the illustrative master controller 102 in the example of FIG. 1A to map one or more inputs to one or more control outputs.

In some embodiments, the machine learning models 250A, 250B, 250C, 250D, . . . may be connected in a suitable manner. For instance, the machine learning model 250D may be adapted to generate an output based on a plurality of inputs, where some of the inputs are output by the machine learning models 250A, 250B, and 250C. Thus, some of the models (e.g., 250A and 250D) may be in series, while others (e.g., 250A, 250B, and 250C) may be in parallel.

In the example shown in FIG. 2B, the machine learning model 250D may be adapted to estimate a total power demand by an electric vehicle. The machine learning model 250D may receive current conditions of one or more energy storage devices in the electric vehicle, kinetic characteristics of the electric vehicle, expected velocity profile of the electric vehicle, expected power loses in one or more auxiliary systems, and/or one or more other inputs. For instance, the machine learning model 250D may receive, from the machine learning model 250A, an estimated state of charge for one of the energy storage devices. The machine learning model 250A may in turn receive voltage, operating temperature, discharge/charge current, and/or one or more other inputs.

Additionally, or alternatively, the machine learning model 250D may receive, from the machine learning model 250B, an expected velocity profile for electrical vehicle. The machine learning model 250B may in turn receive path trajectory, pilot data, historical data, and/or one or more other inputs.

Additionally, or alternatively, the machine learning model 250D may receive, from the machine learning model 250C, an expected power demand for a climate control auxiliary system. The machine learning model 250C may in turn receive ambient temperature, requested temperature, requested fan speed, and/or one or more other inputs.

It should be appreciated that the various inputs and outputs described above and shown in FIG. 2B are provided solely for purposes of illustration. Aspects of the present disclosure are not limited to using a machine learning model with any particular input or combination of inputs, or any particular output. Aspects of the present disclosure are also not limited to using a set of machine learning models arranged in any particular manner, or any machine learning model at all.

In some embodiments, each of the machine learning models 250A, 250B, 250C, 250D, . . . may include an artificial neural network, or a model of some other type. For instance, power demand for a climate control auxiliary system (e.g., driver cabin HVAC) may vary stochastically depending on time of day, weather, number of occupants, driver desired temperature etc. Accordingly, the machine learning model 250C may include an artificial neural network adapted to estimate the power demand based on, for example, one or more of the following inputs.
Driver requested temperature
Driver requested fan speed
Driver requested air channel flow (e.g., whether to have air circulated within the cabin only, or to allow fresh air from outside)
Solar heat input to the cabin through radiation
Number of occupants
Driver requested seat and/or steering wheel heating
Cabin HVAC usage history (e.g., all of the above inputs and corresponding output) for the same time of day for the same range of driver requested temperature.

In some embodiments, a fully connected neural network may be used to determine a cabin HVAC power demand based on one or more of the above inputs and/or one or more other inputs. The input layer of this neural network may have any suitable number of nodes. For instance, there may be one input node for each of the above inputs, or there may be more or fewer input nodes.

In some embodiments, the neural network may have at least one hidden layer. Such a hidden layer may have as many nodes as the input layer, or fewer nodes, depending on desired levels of accuracy, computation efficiency, etc.

Any suitable type of activation function may be used for the neural network, including, but not limited to, sigmoid, rectified linear unit (ReLU), etc. The activation function may be selected in any suitable manner, for example, depending on a depth of the neural network.

In some embodiments, the neural network may have an output node for cabin HVAC power demand. Additionally, or alternatively, the output node may include other information (e.g., attained temperature, rate of change of temperature, etc.). Such information may be provided for monitoring and/or feedback.

In some embodiments, a long short-term memory (LSTM) neural network may be used instead of, or in addition to, a feedforward neural network. One or more output of the LSTM neural network (e.g., cabin HVAC power demand, attained temperature, rate of change of temperature, etc.) may be fed back into the LSTM neural network to establish a time series of recent history, which may improve forecasting accuracy.

It should be appreciated that one or more of the neural network techniques described above, and/or one or more other neural network techniques, may be used to estimate any suitable parameter in addition to, or instead of cabin HVAC power demand. For instance, one or more of the neural network techniques described above, and/or one or more other neural network techniques, may be used to estimate velocity profile, energy storage operating temperature, energy storage state of charge, etc. Additionally, or alternatively, one or more of the neural network techniques described above, and/or one or more other neural network techniques, may be used to determine a power distribution among multiple energy storage devices (e.g., the illustrative energy storage devices 110A-B in the example of FIG. 1A).

In some embodiments, a neural network may be trained using labeled data. Such labeled data may be created for a given neural network by collecting data through testing and/or simulation and annotating the collected data. With respect to the example in FIG. 2B, training data for the machine learning model 250B may be labeled based on velocity ranges (e.g., “10-15 mph,” “15-20 mph,” etc. for each road section in a route).

The inventors have recognized and appreciated that certain limits (e.g., maximum instantaneous charge/discharge current, max/min operating temperature, etc.), if exceeded, may cause damage to an energy storage system. Accordingly, in some embodiments, program logic may be provided to analyze an output of a neural network. For example, if a neural network outputs a discharge current for an energy storage device that exceeds a maximum instantaneous discharge current for that device, that output may not be fed into another component of an energy storage management system (e.g., another neural network). Additionally, or alternatively, the output may be flagged as impossible and/or replaced by the maximum instantaneous discharge current.

In some embodiments, weights and/or biases of a neural network may be trained initially using data from testing and/or simulation. For instance, weights and/or biases for a neural network for estimating a parameter relating to an energy storage device may be trained on data obtained from experiments conducted on the energy storage device and/or computer simulations that apply relevant load profiles to models of the energy storage device. After such initial training, the neural network may be deployed to analyze data obtained during operation of an energy application. Estimates output by the neural network may be compared against measurements to identify differences. The differences, if any, may be used to continue to train the neural network.

It should be appreciated that any one or more suitable methods may be used to train a neural network, as aspects of the present disclosure are not so limited. Examples of training methods include, but are not limited to, gradient descent, Newton, conjugate gradient, quasi-Newton, and/or Levenberg-Marquardt.

The inventors have recognized and appreciated that, in some instances, training data relevant for a particular deployment scenario may be unavailable at the outset. As one example, labeled data may not be available for a new Li-NMC battery. Nevertheless, a neural network for estimating state of charge may be trained on available labeled data for a Li-NCA battery, and may be deployed for the Li-NMC battery. Additional training may be performed as labeled data for the Li-NMC battery becomes available. For instance, state of charge may be measured as the Li-NMC battery is used, and the measured state of charge (along with corresponding inputs) may be used for additional training.

As another example, labeled data from actual drive cycles may not be available for a new vehicle. Nevertheless, a neural network for estimating velocity profile may be trained on available labeled data from standard emission testing (e.g., US EPA FTP-75 urban and highway combined drive cycle). Additional training may be performed as labeled data from actual drive cycles becomes available. For instance, velocity profile may be recorded as the vehicle is driven, and the recorded velocity profile (along with corresponding inputs) may be used for additional training.

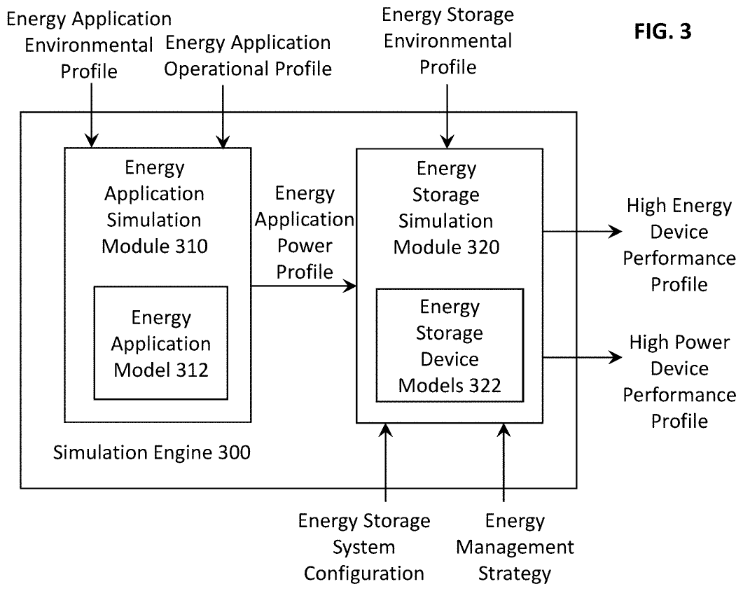

FIG. 3 shows an illustrative simulation engine 300, in accordance with some embodiments. The simulation engine 300 may be used to make predictions about one or more energy applications (e.g., the illustrative energy application 120 in the example of FIG. 1A) and/or one or more energy storage devices (e.g., the illustrative energy application 110A and/or the illustrative energy application 110B in the example of FIG. 1A). For instance, the simulation engine 300 may be used to predict, for any given initial time point t₀, a power profile of an energy application over a simulation period [t₀, t₀+T]. Additionally, or alternatively, the simulation engine 300 may be used to predict, for any given initial time point t₀, a performance profile of an energy storage device over the simulation period [t₀, t₀+T].

In some embodiments, the simulation engine 300 may include an energy application simulation module 310. The energy application simulation module 310 may receive as input an energy application environmental profile and/or an energy application operational profile. The energy application simulation module 310 may apply an energy application model 312 to the energy application environmental profile and/or the energy application operational profile, and may output an energy application power profile P_{EA}.

In some embodiments, the energy application model 312 may represent an energy application (e.g., the illustrative energy application 120 in the example of FIG. 1A), and the energy application power profile P_{EA} may indicate power drawn, and/or supplied, by the energy application over time. For instance, the energy application power profile P_{EA} may include a function of time over the simulation period [t₀, t₀+T]. A positive power value P_{EA}(t) may indicate the energy application 120 is drawing power at time t, whereas a negative power value P_{EA} (t) may indicate the energy application 120 is supplying power at time t; or vice versa.

It should be appreciated that a function of time (e.g., the energy application power profile P_{EA}) may be in discrete time or continuous time. A function of time in discrete time may also be referred to herein as a time series. A time series over the simulation period [t₀, t₀+T] may have any suitable number of time points. For instance, the duration T of the simulation period [t₀, t₀+T] may be one minute, and there may be 60 time points, so that each time step may be one second. Moreover, it should be appreciated that a function of time may be constant over the simulation period [t₀, t₀+T].

In some embodiments, the energy application environmental profile may describe one or more environmental variables over the simulation period [t₀, t₀+T]. For instance, the energy application environmental profile may describe any one or more of the variables listed in Tables 3A-C, where each variable may be provided as a function of time. Likewise, in some embodiments, the energy application operational profile may describe one or more operational variables over the simulation period [t₀, t₀+T]. For instance, the energy application operational profile may describe any one or more of the variables listed in Tables 4A-C, where each variable may be provided as a function of time.

In some embodiments, the energy application model 312 may include a physical model of an energy application, such as the illustrative energy application 120 shown in FIG. 1A. The physical model may describe one or more characteristics of the energy application. The one or more characteristics may be used to compute the energy application power profile P_{EA} based on the energy application environmental profile and/or the energy application operational profile.

In some embodiments, the energy application may include a vehicle, and the energy application model 312 may include one or more of the following characteristics.

TABLE 5A
Vehicle Modeling Characteristics

| Data | Symbol | Unit |
|---|---|---|
| Latitude | lat | °N/S |
| Longitude | lon | °E/W |
| Road Slope | θ | ° |
| Speed Limit Associated with Path Trajectory | υ_{SL} | m/s |
| Proximity to Co-Directional Vehicles | S_{CDV} | m |
| Velocity of Co-Directional Vehicles | υ_{CDV} | m/s |
| Road Surface Classification | RSC | categorical |
| Torque Demand | τ | N-m |
| Maximum Torque Demand | τₘₐₓ | N-m |
| Brake Position Sensor Data | BPS | °/s |
| Total Vehicle Chassis and Passenger/ | mₜₒₜ | kg |
| Payload Mass | | |
| Road Load Coefficient 0 | Fₒ | N |
| Road Load Coefficient 1 | F₁ | N/m |
| Road Load Coefficient 2 | F₂ | N/m² |
| Powertrain Efficiency | η_{PT} | % |
| Regenerative Braking Efficiency | η_{regen} | % |
| Power Electronics Efficiency | η_{PE} | % |
| Ambient Temperature of Operating | T_{amb} | ° C. |
| Environment | | |
| Driver Requested Temperature | T_{AC} | ° C. |
| Absorption, Radiation and Transmission | ART_{Q} | [ ] |
| Ratio of Cabin | | |
| Geospatial Insolation Angle | ϕ | ° |
| Transmission Rotational Velocity | Nₜᵣₐₙₛₘᵢₛₛᵢₒₙ | RPM |
| Transmission Oil Viscosity | μ_{transmission oil} | m²/s |
| Transmission Oil Temperature | T_{transmission oil} | ° C. |
| Spin Loss | τₛₚᵢₙₗₒₛₛ | Nm |
| Brake-by-Wire System Power Demand | P_{brake system} | watts |
| Steer-by-Wire System Power Demand | P_{steering} | watts |
| Energy Storage System Heat Generation | qₙₑₐₜ | watts |
| Energy Storage Operating Temperature Range | T_{ESS} OP | ° C. |
| Energy Storage System Measured Temperature | T_{ESS Measured} | ° C. |
| Ambient Temperature | T_{ambient} | ° C. |

It should be appreciated that aspects of the present disclosure are not limited to using an energy application model that includes physical characteristics of an energy application. Additionally, or alternatively, an energy application model may include behavioral characteristics of an energy application. For instance, an energy application model may include a function that takes, as input, one or more environmental variables and/or one or more operational variables. The function may return, as output, power demand and/or supply of a corresponding energy application. Each of the one or more inputs to this function may be a single value, a time series, or a continuation function over time, and likewise for the output.

In some embodiments, an energy application model may include a behavioral characteristic function that is deterministic. Additionally, or alternatively, a stochastic function may be used, for example, based on one or more probability distributions derived from past observations regarding an energy application. For instance, the energy application may include HVAC equipment, and a model of the HVAC equipment may map temperature to a probability distribution over the HVAC equipment's power demand. The probability distribution may be derived from historical power demand data that has been filtered based on temperature.

In some embodiments, the energy application may include an electric grid, and the energy application model 312 may include one or more of the following characteristics.

TABLE 5B
Electric Grid Modeling Characteristics

| Data | Symbol | Unit |
|---|---|---|
| System Capacity | E_{sys} | MWh |
| Power Electronics Losses | E_{PE} | MWh |
| Transmission & Wiring Losses | E_{T+W} | MWh |
| Wind Speed | υ_{w} | m/s |
| Air Density | ρₐᵢᵣ | kg/m³ |
| Solar Radiation | q” sol | kW/m² |
| Photovoltaic Panel Efficiency | η_{PV} | N/A |
| Array Azimuth | γ_{PV} | ° |
| Array Tilt | θ_{PV} | ° |
| Betz Limit | Cₚ | N/A |
| Blade Radius | r | m |
| Tip Speed Ratio | λ | N/A |
| ISO Forecasted Power Demand | P_{ISO} | MW |
| Instantaneous Power Demand | Pᵢₙₛₜₐₙₜ | MW |
| Historical Power Demand | P_{history} | MW |

Although details are described herein for the energy application model 312, it should be appreciated that such details are provided solely for purposes of illustration. Aspects of the present disclosure are not limited to using any particular technique or combination of techniques for modeling an energy application.

Returning to the example of FIG. 3, the simulation engine 300 may include an energy storage simulation module 320. The energy storage simulation module 320 may receive as input an energy application power profile output by the energy application simulation module 310. Additionally, or alternatively, the energy application simulation module 320 may receive as input an energy storage environmental profile, an energy storage system configuration, and/or an energy management strategy.

In some embodiments, the energy storage system configuration may describe a configuration of one or more energy storage devices. For instance, with a homogeneous energy storage system, the energy storage system configuration may indicate a number of energy storage devices. With a heterogeneous energy storage system, the energy storage system configuration may indicate a plurality of energy storage types. For each energy storage type, the energy storage system configuration may further indicate a number of energy storage devices of that type.

Additionally, or alternatively, if there are multiple energy storage devices, the energy storage system configuration may indicate how the energy storage devices are connected. For instance, some of the energy storage devices may be connected in parallel, and/or some of the energy storage devices may be connected in series.

In some embodiments, the energy storage simulation module 320 may use the energy storage system configuration to select one or more energy storage device models from a collection of energy storage device models 322. For instance, for each energy storage type indicated in the energy storage system configuration, the energy storage simulation module 320 may select an energy storage device model corresponding to that energy storage type.

Examples of energy storage device characteristics include, but are not limited to, the following.

TABLE 6A
General Energy Storage System Characteristics

| Data | Symbol | Units |
|---|---|---|
| Voltage | V_{ESS} | V |
| Minimum Operating Voltage | V_{ESS, min} | V |
| Operating Temperature | T_{ESS} | ° C. |
| Minimum Operating Temperature | T_{ESS, min} | ° C. |
| Maximum Operating Temperature | T_{ESS, max} | ° C. |
| Discharge/Charge Current | I_{ESS} | A |
| Maximum Continuous Discharge Current | I_{ESS, Max} | A |
| | _{Discharge} | |
| Maximum Instantaneous Discharge Current | I_{ESS, Peak} | A |
| | _{Discharge} | |
| Maximum Instantaneous Discharge Current | t_{ESS, Peak} | s |
| Duration | _{Discharge} | |
| Maximum Charge Current | I_{ESS, Max Charge} | A |
| Energy Storage System State of Charge | SoC_{ESS} | % |
| Energy Storage System Maximum State of | SoC_{ESS, min} | % |
| Charge | | |
| Energy Storage System Minimum State of | SoC_{ESS, min} | % |
| Charge | | |
| Energy Storage System State of Health | SoH_{Ess} | % |
| Energy Storage Average State of Charge | SoC_{ESS, Average} | % |
| Energy Storage System Maximum Nominal | E_{ESS, Max} | kWh |
| Capacity | _{Nominal} | |
| Energy Storage System Maximum Capacity | E_{ESS, Max} | kWh |
| Energy Storage System Equivalent Series | ESR_{ESS} | Ω |
| Resistance | | |
| Number of Equivalent Full Discharge Cycles | N_{ESS} | [ ] |

In some embodiments, the energy storage device models 322 may include a model for a high energy device and a model for a high power device. For instance, with reference to the example of FIG. 1A, the energy storage device models 322 may include respective models of the illustrative energy storage devices 110A and 110B. In some embodiments, testing data, dynamically collected data (e.g., sensor measurements), and/or historical data may be used to build the models of the illustrative energy storage devices 110A and 110B.

In some embodiments, an energy storage device model may include a relational model. For example, an energy storage device model may include a model expressing relationships between voltage and capacity at one or more applicable discharge currents, operating temperatures, state of health values, etc. Additionally, or alternatively, an energy storage device model may include a model expressing relationships between internal resistance and capacity at one or more applicable discharge currents, operating temperatures, state of health values, etc.

In some embodiments, relationships may be provided for all current values between a minimum discharge current (e.g., 0) and a maximum discharge current, all temperature values between a minimum operating temperature and a maximum operating temperature, all state of health values between an initial value (e.g., 100%) and an end-of-life value (e.g., 80%), etc. However, that is not required. In some embodiments, a relationship that is not provided may be interpolated based on available relationships.

In some embodiments, one or more energy storage characteristics (e.g., peak current duration, operating temperature limits, state of charge limits, etc.) may be provided by an energy storage device manufacturer. Such characteristics may serve as guidelines to extend system life. Additionally, or alternatively, such characteristics may be used to set limits on energy storage device operation.

Examples of characteristics of an electrochemical battery include, but are not limited to, the following.

TABLE 6B
Electrochemical Battery Storage System Characteristics

| Data | Symbol | Units |
|---|---|---|
| Voltage | V_{BESS} | V |
| Minimum Operating Voltage | V_{BESS, min} | V |
| Operating Temperature | T_{BESS} | ° C. |
| Minimum Operating Temperature | T_{BESS, min} | ° C. |
| Maximum Operating Temperature | T_{BESS, max} | ° C. |
| Discharge/Charge Current | I_{BESS} | A |
| Maximum Continuous Discharge Current | I_{BESS, Max Discharge} | A |
| Maximum Instantaneous Discharge Current | I_{BESS, Peak Discharge} | A |
| Maximum Instantaneous Discharge Current | t_{BESS, Peak Discharge} | s |
| Duration | | |
| Maximum Charge Current | I_{BESS, Max Charge} | A |
| Battery Storage System State of Charge | SoC_{BESS} | % |
| Battery Storage System Maximum State of | SoC_{BESS, min} | % |
| Charge | | |
| Battery Storage System Minimum State of | SoC_{BESS, min} | % |
| Charge | | |
| Battery Storage System State of Health | SoH_{BESS} | % |
| Battery Storage Average State of Charge | SoC_{BESS, Average} | % |
| Battery Storage System Maximum | E_{BESS, Max} | kWh |
| Nominal Capacity | _{Nominal} | |
| Battery Storage System Maximum Capacity | E_{BESS, Max} | kWh |
| Battery Storage System Equivalent Series | E_{SRBESS} | Ω |
| Resistance | | |
| Number of Equivalent Full Discharge | N_{BESS} | [ ] |
| Cycles | | |

In some embodiments, modeling of a supercapacitor energy storage system may be similar to that of an electrochemical battery energy storage system, but with an additional modeling characteristic of system capacitance. Capacitance data may be provided by an energy storage device manufacturer, and may be used to model system energy and state of charge.

Examples of characteristics of a supercapacitor include, but are not limited to, the following.

TABLE 6C
Supercapacitor Energy Storage System Characteristics

| Data | Symbol | Units |
|---|---|---|
| Voltage | V_{SCESS} | V |
| Minimum Operating Voltage | V_{SCESS, min} | V |
| System Capacitance | C_{SCESS} | F |
| Operating Temperature | T_{SCESS} | ° C. |
| Minimum Operating Temperature | T_{SCESS, min} | ° C. |
| Maximum Operating Temperature | T_{SCESS, max} | ° C. |
| Discharge/Charge Current | I_{SCESS} | A |
| Maximum Continuous Discharge Current | I_{SCESS, Max} | A |
| | _{Discharge} | |
| Maximum Instantaneous Discharge Current | I_{SCESS, Peak} | A |
| | _{Discharge} | |
| Maximum Instantaneous Discharge Current Duration | t_{SCESS, Peak} | s |
| | _{Discharge} | |
| Maximum Charge Current | I_{SCESS, Max Charge} | A |
| Supercapacitor Energy Storage System State of Charge | SoC_{SCESS} | % |
| Supercapacitor Energy Storage System Maximum State of Charge | SoC_{SCESS, min} | % |
| Supercapacitor Energy Storage System Minimum State of Charge | SoC_{SCESS, min} | % |
| Supercapacitor Energy Storage System State of Health | SoH_{SCESS} | % |
| Supercapacitor Energy Storage Average State of Charge | SoC_{SCESS, Average} | % |
| Supercapacitor Energy Storage System Maximum Nominal | E_{SCESS, Max} | kWh |
| Capacity | _{Nominal} | |
| Supercapacitor Energy Storage System Maximum Capacity | E_{SCESS, Max} | kWh |
| Supercapacitor Energy Storage System Equivalent Series Resistance | ESR_{SCESS} | Ω |
| Number of Equivalent Full Discharge Cycles | N_{SCESS} | [ ] |

In some embodiments, the energy storage environmental profile may describe one or more environmental variables over the simulation period [t₀, t₀+T]. For instance, the energy storage environmental profile may describe any one or more of the variables listed in Tables 3A-C, where each variable may be provided as a function of time.

In some embodiments, the energy storage simulation module 320 may maintain one or more state variables, which may have one or more respective initial values at time t₀, and may evolve over the simulation period [t₀, t₀+T]. Examples of state variables include, but are not limited to, state of charge, state of health, voltage, current, C-rate, charging/discharging efficiency, etc. In some embodiments, different energy storage devices in an energy storage system configuration (e.g., a high energy device and a high power device) may have different state variables.

In some embodiments, the simulation period [t₀, t₀+T] may include N control cycles, where each control cycle may have a duration of T/N. At the beginning of a control cycle, the energy storage simulation module 320 may apply the energy management strategy based on the energy application power profile, the energy storage environmental profile, and/or one or more respective values of the one or more state variables at the beginning of the control cycle. The energy management strategy may output a power distribution to be effectuated during the control cycle. The energy storage simulation module 320 may then use the one or more energy storage device models, which may be selected based on the energy storage system configuration, to determine how the one or more state variables may evolve during the control cycle. For instance, the energy storage simulation module 320 may determine a time series for a state variable during the control cycle. The time series may include just one value (e.g., a value of the state variable at the end of the control cycle), or multiple values (e.g., values of the state variable throughout the control cycle).

In some embodiments, the energy storage simulation module 320 may repeat the above process N times, where each state variable may be initialized at the beginning of each control cycle based on the state variable's value at the end of the previous control cycle. Accordingly, for each state variable, the energy storage simulation module 320 may output the values of the state variable as a time series for the entire simulation period [t₀, t₀+T]. Additionally, or alternatively, the energy storage simulation module 320 may output changes in the state variable (e.g., ΔSoC, ΔSoH, etc.) as a time series for the entire simulation period [t₀, t₀+T].

In some embodiments, a time series for an entire simulation period may be obtained by concatenating time series for individual control cycles. Additionally, or alternatively, a time series for an entire simulation period may include derived values, such as an average value for each control cycle.

In some embodiments, the energy storage simulation module 320 may output a performance profile for each energy storage device in the energy storage system configuration. Such a performance profile may include, for each state variable pertaining to the corresponding energy storage device, the time series for the entire simulation period [t₀, t₀+T] for that state variable.

It should be appreciated that aspects of the present disclosure are not limited to the details of implementation shown in FIG. 3 and described above. Such details are provided solely for purposes of illustration. For instance, although the example shown in FIG. 3 includes one energy application and two energy storage devices (i.e., a high energy device and a high power device), aspects of the present disclosure are not so limited. The techniques described herein may be used to manage any number of one or more energy applications and/or any number of one or more energy storage devices.

Furthermore, one or more of the inputs may be omitted, or replaced by one or more other inputs. For example, if the energy storage system configuration is fixed, that input may be omitted. Instead, one or more corresponding energy storage device models may be selected ahead of time.

The inventors have recognized and appreciated that state variables may evolve differently depending on which energy management strategy is applied, even if the energy storage system configuration, the energy application power profile, and the energy storage environment profile remain the same. Accordingly, energy storage device performance profiles resulting from different energy management strategies may be compared to determine which energy management strategy may be more desirable.

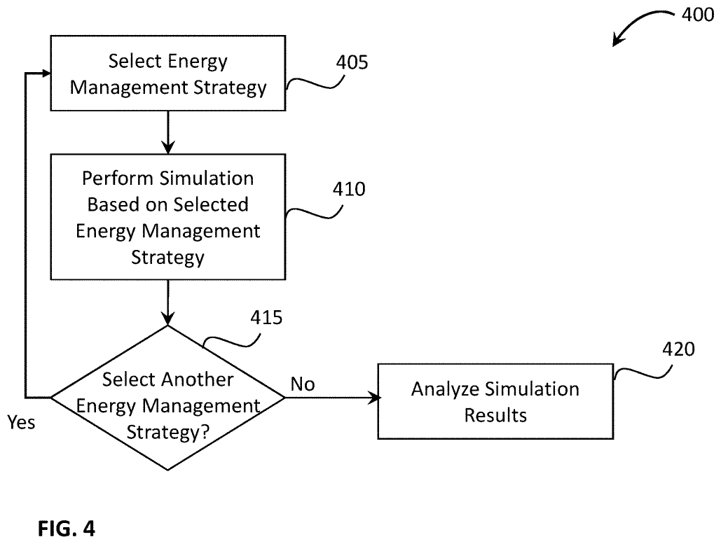

FIG. 4 shows an illustrative process 400 for analyzing energy management strategies, in accordance with some embodiments. For instance, the process 400 may be performed by an energy storage management system (e.g., the illustrative remote energy storage management system 150 and/or the illustrative local energy storage management system 160 in the example of FIG. 1B) to determine a desirable energy management strategy in real time (e.g., onboard a vehicle, at a power station, from a cloud server, etc.). However, it should be appreciated that the process 400 is not limited to being performed in real time.

At act 405, the energy storage management system may select an energy management strategy, for example, from the illustrative collection of energy management strategies 154 in the example of FIG. 1B. The selected energy management strategy may be based on a machine learning model, such as the illustrative machine learning model 200 in the example of FIG. 2A. However, it should be appreciated that aspects of the present disclosure are not limited to using any particular type of energy management strategy.

In some embodiments, the selected energy management strategy may be a baseline energy management strategy to which one or more other energy management strategies are to be compared. For instance, the selected energy management strategy may be an energy management strategy that is currently in use, and the one or more other energy management strategies may be one or more candidates for replacing the current other energy management strategy.

At act 410, the energy storage management system may perform simulation based on the selected energy management strategy. For instance, the selected energy management strategy may be provided as input to the illustrative simulation engine 300 in the example of FIG. 3. In some embodiments, one or more additional inputs may be provided, such as an energy application environmental profile, an energy application operational profile, an energy storage environment profile, and/or an energy storage system configuration. The simulation engine 300 may output one or more energy storage device performance profiles, which may be stored by the energy storage management system for further analysis.

At act 415, the energy storage management system may determine whether to select another energy management strategy for simulation. If it is determined that another energy management strategy is to be selected, the energy storage management system may return to act 405 to select a next energy management strategy. The energy storage management system may then, at act 410, perform simulation based on the next energy management strategy, along with the same energy application environmental profile, the same energy application operational profile, the same energy storage environment profile, and/or the same energy storage system configuration.

At act 420, simulation results for one or more selected energy management strategies may be analyzed. For instance, in some embodiments, the simulation engine 300 may output one or more energy storage device performance profiles for a selected energy management strategy. An energy storage device performance profile may include, for each state variable, a time series of values of that state variable over a simulation period [t₀, t₀+T]. Such a time series may be evaluated in a suitable manner to produce a score for that state variable. For instance, a time series of energy storage device state of charge values may be scored in such a way that a higher state of charge at the end of the simulation period, and/or a small variance of the state of charge values across the simulation period, may result in a higher score.

It should be appreciated that aspects of the present disclosure are not limited to any particular way of scoring a time series for a state variable. Moreover, different state variables may be scored in different ways.

In some embodiments, an overall score for a selected energy management strategy may be obtained by combining individual scores of state variables in the one or more energy storage device performance profiles output by the simulation engine 300 for that energy management strategy. For instance, the state variables may have respective weights associated therewith, and the overall score may be computed as a weighted sum of the individual scores.

The respective weights associated with the state variables may be determined in any suitable manner. In some embodiments, different sets of weights may be provided for different modes of an energy application. For instance, for an electric vehicle, there may be a range extending mode, a high acceleration mode, a mode for preserving state of health of an energy storage device, etc. Additionally, or alternatively, different sets of weights may be provided for different environments. For instance, for HVAC equipment, there may be different modes depending on time of year (e.g., spring, summer, fall, and winter).

Returning to act 420, the energy storage management system may, in some embodiments, compare the selected energy management strategies based on the respective scores. For instance, a highest scoring energy management strategy may be selected. Additionally, or alternatively, scores of one or more candidate energy management strategies may be compared against a score of an energy management strategy that is currently in use. If the current energy management strategy scores higher than all of the one or more candidates, the energy storage management system may continue to use the current energy management strategy. Otherwise, the energy storage management system may replace the current energy management strategy with a highest scoring candidate.

It should be appreciated that aspects of the present disclosure are not limited to the details of implementation shown in FIG. 4 and described above. Such details are provided solely for purposes of illustration.

In some embodiments, the illustrative collection of energy management strategies 154 in the example of FIG. 1B may include an energy management strategy that is based on a predictive technique. For instance, various paths through a decision graph may be explored to predict which path may lead to a more desirable outcome.

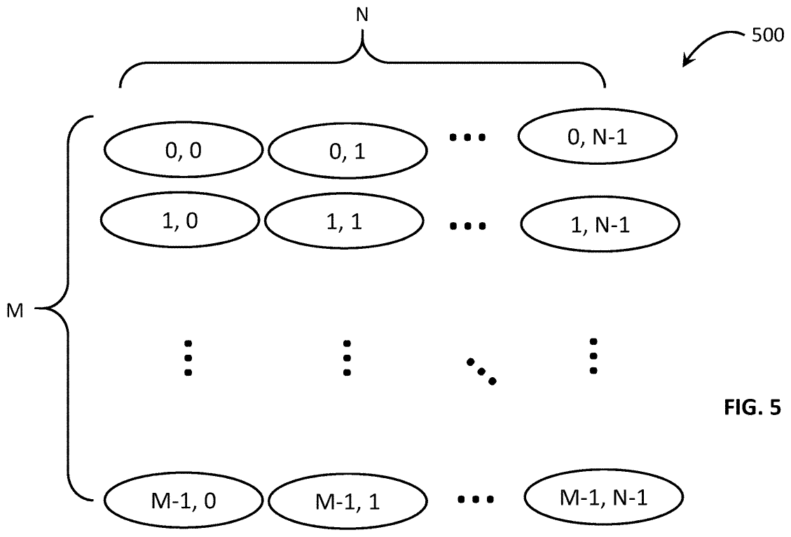

FIG. 5 shows an illustrative decision graph 500, in accordance with some embodiments. In this example, the decision graph 500 includes a plurality of nodes organized into an M×N matrix. However, it should be appreciated that aspects of the present disclosure are not limited to using any particular type of decision graph, or any decision graph at all.

In some embodiments, each row in the decision graph 500 may correspond to a certain control decision. For instance, there may be 11 rows (M=11), each row corresponding to a certain power split between a high energy device (HED) and a high power device (HPD), such as 100% HPD (m=0), 90% HPD and 10% HED (m=1), . . . , 10% HPD and 90% HED (m=9), and 100% HED (m=10). However, it should be appreciated that aspects of the present disclosure are not limited to any particular number of rows, or any particular type of control decision.

In some embodiments, each column in the decision graph 500 may correspond to a time point within a prediction horizon. For instance, the prediction horizon may be 10 seconds, and there may be 11 columns (N=11). The leftmost column (n=0) may correspond to the beginning of the prediction horizon, and each subsequent column (n+1) may correspond to a time point that is one second after a time point of the previous column (n). In some embodiments, an interval between two adjacent time points may correspond to one control cycle. However, it should be appreciated that aspects of the present disclosure are not limited to any particular number of columns, or any particular time scale. For instance, in some embodiments, the prediction horizon may include a full length of a drive cycle.

In some embodiments, a node in the leftmost column (n=0) of the decision graph 500 may be selected as an initial node, based on a current control status (e.g., a current power split between a high energy device and a high power device). One or more paths starting from this initial node may be evaluated. For instance, a cost may be determined for each path, and a least costly path may be output as a selected energy management strategy. However, it should be appreciated that aspects of the present disclosure are not limited to any particular way of selecting a path to be output as the selected energy management strategy. In some embodiments, a cost may be determined on a per-node basis (as opposed to a per-path basis), and a path may be selected based on per-node costs.

In some embodiments, a per-node cost function may receive, as input, one or more variables, such as change of state of charge (ΔSoC), charge or discharge rate (C-rate), change of state of health (ΔSoH), charging/discharging efficiency (η), etc. For instance, a per-node cost may be computed as a weighted sum, such as the following.

Cost=f(ΔSoC,C−rate,η,ΔSoH)=a*ΔSoC+b*C−rate+c*η+d*ΔSoC

In some embodiments, a variable may take on a unit-less value that may be scaled appropriately. For example, ΔSoC may be expressed as a percentage change. However, it should be appreciated that aspects of the present disclosure are not limited to using any particular type of values.

In some embodiments, the weights a, b, and/or c may be determined (e.g., through experiments) before an energy management strategy is deployed. Additionally, or alternatively, the weights a, b, and/or c may be adaptively determined based on one or more control objectives (e.g., whether to save more energy at the expense of efficiency, or to increase efficiency at the expense of energy storage).

In some embodiments, cost may be computed based on equivalent series resistance (ESR). For instance, in an energy storage system with a high power device (HPD) and a high energy device (HED), cost may be computed as follows.

Cost=a*ESR(HPD)+b*ESR(HED)

In this example, the weights a and b may be determined based on which of the HPD and the HED is to be prioritized. For instance, if use of the HED is to be reduced (e.g., to increase lifetime of the HED), the weight b may be increased to associate higher cost with HED usage.

In some embodiments, a per-node cost may be computed for each node in the rightmost column (n=N−1) of the decision graph 500, using the illustrative ESR cost formula above (or another suitable formula). For instance, for node (1, N−1) (10% HED, 90% HPD), an HED power output may be computed as 10% of an estimated total power demand at time N−1. (The estimated total power demand may be provided as an input) Likewise, an HPD power output may be computed as 90% of the estimated total power demand at time N−1. Using respective energy storage models of the HED and the HPD, the power outputs may be used to compute respective currents, which may in turn be used to compute respective ESRs.

In some embodiments, a least costly node in the rightmost column (n=N−1) may be selected as a terminal point of a path to be output for the selected energy management strategy. Then, a per-node cost may be computed for each node in the previous column (n=N−2), again using the illustrative ESR cost formula above (or another suitable formula), and a least costly node may be selected for the previous column (n=N−2). This may be repeated until the second column is reached (n=2), so that a least costly node may be selected from each column except for the leftmost column. These least costly nodes, along with the initial node, may be output for the selected energy management strategy.

In some embodiments, the illustrative decision graph 500 may be used to minimize a cumulative cost over a short prediction horizon for a known velocity or total power demand profile. Such a velocity or total power demand profile may be estimated using one or more neural networks. Additionally, or alternatively, such a velocity or total power demand profile may be obtained from an energy application (e.g., the illustrative energy application 120 shown in FIG. 1A).

In some embodiments, a cumulative cost minimization process may may start with the rightmost column (n=N−1), and may select a least costly node X_{N-1} as described above. The cost computed for the least costly node X_{N-1} may be denoted Cost_{N-1}. The cumulative cost minimization process may proceed to the second to last column (n=N−2), and may compute a cumulative cost for each node Y in the second to last column (n=N−2) as follows.

Cost_{cumulative}(Y)=Cost_{N-1}+Cost(Y)

In this cost formula, Cost(Y) is the ESR cost described above, applied to node Y. For instance, For instance, if node Y is (1, N−2) (10% HED, 90% HPD), an HED power output may be computed as 10% of an estimated total power demand at time N−2. Likewise, an HPD power output may be computed as 90% of the estimated total power demand at time N−2. Using respective energy storage models of the HED and the HPD, the power outputs may be used to compute respective currents, which may in turn be used to compute respective ESRs. A least costly node X_{N-2} in the second to last column (n=N−2) may be selected, and the associated cost may be denoted Cost_{N-2}.

In some embodiments, the cumulative cost minimization process may select a node X_{N-3} from the third to last column (n=N−3), a node X_{N-4} from the fourth to last column (n=N−4), etc. in a similar fashion, where costs are accumulated from a current column (n=N−i) through the last column (n=N−1).

In some embodiments, a path for the selected energy management strategy may be determined as follows. For instance, at the first column (n=N−1), HPD state of charge SOC_{HPD,1} may be set to a corresponding initial SOC value (which may be provided as an input), and likewise for HED state of charge SOC_{HED,1}. At the second column (n=N−2), HPD state of charge SOC_{HPD,2} may be computed as follows.

SOC_{HPD,2}=SOC_{HED,1}−(100*HPD Power Demand at node X₂)/Capacity_{HPD}

In this formula, the HPD power demand at node X₂ may be determined based on the estimated total power demand for time n=2 and the percentage allocated to the HPD at node X₂. For instance, if node X₂ is (1, 2), 90% of the estimated total power demand for time n=2 may be allocated to the HPD. HED state of charge SOC_{HED,2} may be computed in a similar manner. This may be repeated to compute HPD state of charge SOC_{HPD,1} and HED state of charge SOC_{HED,1} for all i.

It should be appreciated that the cumulative cost minimization process described above is provided solely for purposes of illustration. Aspects of the present disclosure are not limited to any particular way to minimize cumulative cost, or any minimization of cumulative cost all. For instance, in some embodiments, the following formula may be used Cost_{cumulative}.

Cost_{cumulative}(node Y in column i)=FutureCostᵢ₊₁+Cost(Y)

In this example, FutureCostᵢ₊₁ may be based on Costᵢ₊₁ (as in the earlier example) and/or some other information (e.g., change in state of charge).

In some embodiments, one or more safety constraints may be applied during a cumulative cost minimization process. For instance, a high cost may be associated with a control decision that may result in an unsafe condition (e.g., ΔSoC exceeding a safety threshold). As a result, the cumulative cost minimization process may not select a path that involves such a control decision.

The inventors have recognized and appreciated that performance of an energy management strategy may depend on a context in which the energy management strategy is deployed. For instance, an energy management strategy may map one or more inputs to a power distribution among a plurality of energy storage devices associated an energy application. Such an energy management strategy may perform better or worse depending on conditions of the energy storage devices, the energy application itself, and/or an environment in which the energy application is operating.

Accordingly, in some embodiments, techniques are provided for selecting an energy management strategy from a plurality of energy management strategies. Such a technique may attempt to strike a desired balance between: (1) selecting an energy management strategy that is known to perform well in a certain context, and (2) trying other energy management strategies to see if any of the other energy management strategies may perform even better in that context.

In some embodiments, an energy management strategy may receive, as input, a parameter value output by an estimation model. The inventors have recognized and appreciated that accuracy of an estimation model may depend on a context in which the estimation model is deployed. For instance, an estimation model may map one or more inputs to an estimated value of a parameter relating to an energy application, an energy storage device associated the energy application, or an environment in which the energy application is operating. The estimated value of the parameter may be an estimate of a current or future value of the parameter. Such an estimation model may be more or less accurate (e.g., estimated value matching observed value) depending on conditions of the energy storage devices, the energy application itself, and/or an environment in which the energy application is operating.

The inventors have recognized and appreciated that techniques for selecting an energy management strategy from a plurality of energy management strategies may also be used for selecting an estimation model from a plurality of estimation models. Such a technique may attempt to strike a desired balance between: (1) selecting an estimation model that is known to accurate in a certain context, and (2) trying other estimation models to see if any of the other estimation models may be even more accurate in that context.

The inventors have further recognized and appreciated that it may be desirable to share knowledge about energy management strategy performance and/or estimation model accuracy across similar energy applications, such as electrical vehicles that are similarly constructed and/or similarly equipped. For instance, Vehicle A and Vehicle B may belong to a same class of vehicles (e.g., having the same type of energy storage system, or ESS). Vehicle A may be based in Sydney, Australia, whereas Vehicle B may be based in Oslo, Norway. With an ambient temperature of −10° C. and an ESS operating temperature of +10° C., the capacity of the ESS in Vehicle B may be found to be 3% higher than estimated. Moreover, at a 1.3C discharge, the equivalent series resistance (ESR) of the ESS in Vehicle B may be found to be 7% lower than estimated.

In some embodiments, data collected from other vehicles in the same class operating in the same context (e.g., ambient temperature within a first range of −10° C., and/or ESS operating temperature within a second range of +10° C.) may be analyzed to determine if similar discrepancies are also observed (e.g., capacity discrepancies within a third range, and/or ESR discrepancies within a fourth range). If so, it may be inferred that the estimation model for capacity and/or the estimation model for ESR that are currently deployed in Vehicle B may be inaccurate in that context. Otherwise, it may be inferred that the discrepancies observed at Vehicle B may be due to data noise, which may advantageously prevent unnecessary updates to the estimation models in Vehicle B.

Additionally, or alternatively, data collected from the same vehicle operating in the same context repeatedly may be analyzed to determine if similar discrepancies are observed consistently (e.g., over a threshold percentage of occurrences). If so, it may be inferred that a currently deployed estimation model may be inaccurate in that context. Otherwise, it may be inferred that discrepancies observed on just a few occasions may be due to data noise.

In some embodiments, if it is determined that a currently deployed estimation model may be inaccurate in a given context, the estimation model may be replaced by a model that is deemed more accurate in that context. For instance, if it is determined that similar discrepancies in capacity and ESR are observed across many vehicles in the same class operating in the same context (e.g., above a threshold percentage of such vehicles), estimation models in such vehicles may be replaced by models that are deemed more accurate in that context. This may be done in any suitable manner (e.g., via over-the-air updates), and may allow energy management strategies in such vehicles to take advantage of improved ESS performance in that context.

It should be appreciated that the class of vehicles to be considered may be defined in any suitable manner. In some embodiments, vehicles in the same class may be of the same make, model, and/or year, in addition to, or instead of, having the same type of energy storage system.

In some embodiments, replacement models may be deployed selectively. For instance, if a discrepancy between estimated value and observed value is above a selected percentage threshold, deployment of a replacement model may be triggered. Additionally, or alternatively, deployment of a replacement model may be based on similarity between contexts. For example, since Vehicle A is in a different context (e.g., much higher ambient temperature and ESS operating temperature), estimation models in Vehicle A may not be replaced immediately. However, program logic may be provided to trigger replacement of the estimation models when colder conditions are experienced in the future.

Similarity between contexts may be determined in any suitable manner. For instance, in some embodiments, given two values of a same observable feature, a normalized difference may be provided, which may be a value in [0,1]. Given two contexts based on the same underlying set of features, a difference between the two contexts may be calculated as a weighted sum of respective differences between corresponding feature values. However, it should be appreciated that aspects of the present disclosure are not limited to comparing contexts in any particular way, or at all.

In some embodiments, techniques are provided for selecting a model from a model category comprising a plurality of candidate models. For instance, a model category may be provided that comprises a plurality of energy management strategies. Additionally, or alternatively, a model category may be provided that comprises a plurality of estimation models for a parameter relating to an energy application. Such estimation models may be referred to as energy application models. Additionally, or alternatively, a model category may be provided that comprises a plurality of estimation models for a parameter relating to an energy storage device associated with the energy application. Such estimation models may be referred to as energy storage device models. Additionally, or alternatively, a model category may be provided that comprises a plurality of estimation models for a parameter relating to an environment in which the energy application is operating. Such estimation models may be referred to as environment models.

In some embodiments, a context may include a plurality of values, where each value may correspond to an observable feature. For instance, a context C may include a value of a feature relating to an environment in which an energy application is operating (e.g., an ambient temperature, a road condition, etc.), a value of a feature relating to the energy application (e.g., a total vehicle mass, a time to destination, a driver requested velocity, a driver requested cabin temperature, etc.), and/or a value of a feature relating to one or more energy storage devices associated with the energy application (e.g., an energy storage operating temperature, a state of charge, etc.).

In some embodiments, techniques are provided for selecting a model from a model category so as to increase one or more rewards. As one example, a model category M may include a plurality of energy management strategies for an ESS of an electric vehicle, and an energy management strategy m may be selected to increase the ESS's state of health upon the vehicle's arrival at a destination. Thus, a reward function r(C, m) may depend on the ESS's state of health after deploying the energy management strategy m in the context C. Additionally, or alternatively, the reward function r(C, m) may be provided to increase drive cycle efficiency (kWh/km), energy recovered during regenerative braking instances, etc., and/or decrease thermal losses, cyclical oscillation of high energy device, second derivative of high energy device power demand, etc.

As another example, a model category M may include a plurality of estimation models for a parameter, and an estimation model m may be selected to increase accuracy. Thus, a reward function r(C, m) may depend on a difference between an estimated value of the parameter and an observed value of the parameter.

In some embodiments, if an energy management strategy m has been deployed multiple times in a context C, a suitable statistic of a reward may be used, such as mean, medium, mode, maximum, minimum, etc.

In some embodiments, repeated selections from a model category M may be performed with an objective to increase aggregate reward. At each selection, two possible approaches may be taken: (1) exploitation—attempting to increase reward based on what is currently known about the models in M; and (2) exploration—attempting to learn more about the models in M.

For instance, an exploration parameter 0<∈≤1 may be chosen. The exploration approach may be chosen with probability ∈, whereas the exploitation approach may be chosen with probability 1−∈. An illustrative technique using such an exploration parameter is shown in the pseudo code below.

```
input: context C, exploration parameter 0 < ϵ ≤ 1, model category M
output: selected model m ϵ M
if not every model in M has been deployed in the context C
then
  select model m uniformly at random from model(s) in M that have
  not been deployed in the context C
else
  select number u uniformly at random from [0, 1] ;
  if u ≥ ϵ then
    select model m with highest average reward r̅(C, m) seen so
    far in the context C
  else
    select model m uniformly at random from M
end
```

In this example, exploration is favored initially, until all models in the model category M have been deployed at least once in the context C. Thereafter, the exploration parameter ∈ is used to choose between exploitation and exploration.

It should be appreciated that the above technique is provided solely for purposes of illustration. One or more variations of this technique, and/or one or more other techniques, may be used to select models from a model category to increase reward in a given context. For instance, in some embodiments, a rule may be used to eliminate one or more models from the model category M that are deemed to be unsuitable in the context C.

Other examples of techniques that may be used are discussed in “A Practical Method for Solving Contextual Bandit Problems Using Decision Trees” by Elmachtoub et al.³ ³ In Proceedings of the 33rd Conference on Uncertainty in Artificial Intelligence (UAI 2017).

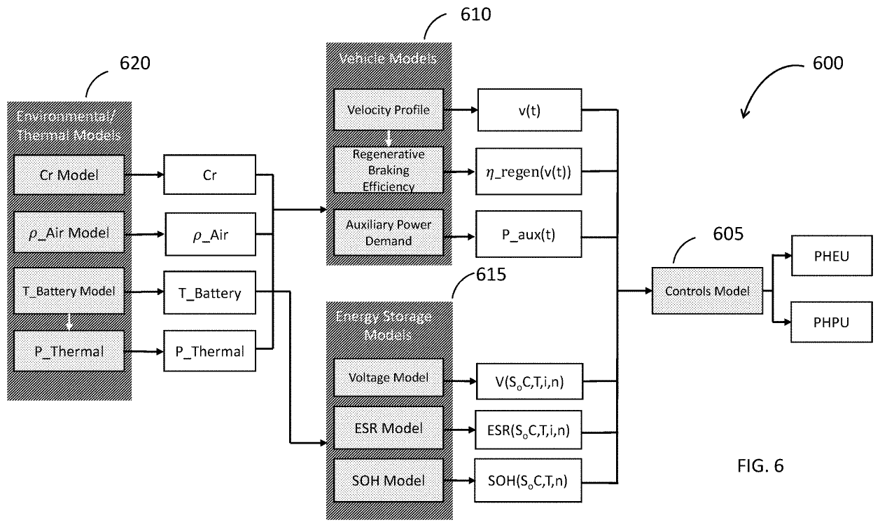

FIG. 6 shows an illustrative network 600 of model categories, in accordance with some embodiments. In this example, the network 600 includes a model category 605 comprising a plurality of energy management strategies. For instance, each energy management strategy in the model category 605 may map one or more inputs to a power distribution between a high energy device and a high power device (e.g., the illustrative energy storage devices 110A-B in the example of FIG. 1A).

In some embodiments, an input to the model category 605 may be provided by another model category. For instance, the model category 605 may receive an input from a model category comprising energy application models, such as a model category comprising estimation models for velocity profile, a model category comprising estimation models for regenerative braking efficiency, a model category comprising estimation models for auxiliary power demand, etc. Such model categories are shown in a group 610 in FIG. 6.

Additionally, or alternatively, the model category 605 may receive an input from a model category comprising energy storage device models, such as a model category comprising estimation models for voltage, a model category comprising estimation models for equivalent series resistance (ESR), a model category comprising estimation models for state of health (SOH), etc. Such model categories are shown in a group 615 in FIG. 6.

In some embodiments, a model category comprising estimation models may in turn receive an input from another model category comprising estimation models. For instance, a model category in the group 610 or 615 may receive an input from a model category comprising environment models, such as a model category comprising estimation models for rolling coefficient, a model category comprising estimation models for air density, etc. Additionally, or alternatively, a model category in the group 610 or 615 may receive an input from a model category comprising thermal models, such as a model category comprising estimation models for energy storage device operating temperature, a model category comprising estimation models for thermal management power (e.g., power used to maintain energy storage device operating temperature within a selected range), etc.

The inventors have recognized and appreciated that, though the thermal models in the example of FIG. 6 are energy storage device models, the thermal models may receive inputs relating to an environment in which an energy application is operating. Thus, in some embodiments, selection of a thermal model may be based on historical data segmented by one or more environmental conditions. Accordingly, in FIG. 6, the thermal models are shown in a same group 620 as the environmental models.

In some embodiments, selection of models may proceed from upstream to downstream in the network 600. For instance, a model may be selected from each model category that has no input from any other model category. Such a selected model may be used to obtain an estimated parameter value, which may in turn be provided as input to a downstream model category.

The inventors have recognized and appreciated that observable features that are relevant for selection from a first model category (e.g., velocity profile) may be different from those that are relevant for selection from a second model category (e.g., state of health). Accordingly, in some embodiments, a first context may be used when selecting a model from the first model category, while a second context, different from the first context, may be used when selecting a model from the second model category. However, it should be appreciated that aspects of the present disclosure are not limited to using different contexts for different model categories.

Additionally, or alternatively, different exploration parameters (c) and/or different reward histories may be used for different model categories. However, it should be appreciated that aspects of the present disclosure are not limited to using an exploration parameter or a reward history to select a model from a model category.

The inventors have recognized and appreciated that, when a master controller (e.g., the illustrative master controller 102 in the example of FIG. 1A) compares two energy management strategies to see which energy management strategy will perform better, the master controller may rely on one or more parameters such as projected power demand, projected energy storage device state of health, etc. Likewise, when the master controller estimates a parameter such as projected energy storage device state of health, the master controller may rely on one or more other parameters such as projected energy storage operating temperature. Thus, inaccurate modeling of parameters may, directly or indirectly, lead to false promises and/or missed opportunities for improved performance.

The inventors have further recognized and appreciated that a network of model categories, such as the network 600 in the example of FIG. 6, may be used to provide adaptive control while improving accuracy of estimated parameters based on which the adaptive control is performed. For instance, adaptive control may be provided via the model category 605, while accuracy improvements may be provided via model categories in the groups 610, 615, and 620.

In some embodiments, a model may be selected from a model category in the group 620. Such selection may be based on:
historical data segmented by one or more criteria such as one or more environmental conditions;
dynamically obtained data (e.g., sensor measurements);
reward history of that model category;
etc.
   The selected model may be applied to the historical data and/or the dynamically obtained data to determine an estimated parameter value. This estimated value may then be provided to one or more model categories in the groups 610 and 615.

In some embodiments, a model may be selected from a model category in the group 610. Such selection may be based on:
one or more estimated parameter values from the group 620;
historical data segmented by one or more criteria such as geography, driver history, vehicle platform, etc.;
dynamically obtained data (e.g., sensor measurements);
reward history of that model category;
etc.
   The selected model may be applied to the historical data and/or the dynamically obtained data to determine an estimated parameter value. This estimated value may then be provided to the model category 605.

In some embodiments, a model may be selected from a model category in the group 615. Such selection may be based on:
one or more estimated parameter values from the group 620;
historical data segmented by one or more criteria such as deployed energy storage system type;
dynamically obtained data (e.g., sensor measurements);
reward history of that model category;
etc.
   The selected model may be applied to the historical data and/or the dynamically obtained data to determine an estimated parameter value. This estimated value may then be provided to the model category 605.

In some embodiments, a model may be selected from the model category 605. Such selection may be based on:
one or more estimated parameter values from the groups 610 and 615;
historical data segmented by one or more criteria such as one or more driving conditions, driver behavior, one or more vehicle characteristics, etc.;
dynamically obtained data (e.g., sensor measurements);
reward history of the model category 605;
etc.
   The selected model may be applied to the historical data and/or the dynamically obtained data to determine instantaneous and/or future power demand of a high energy device, instantaneous and/or future power demand of a high power device (if a heterogenous energy storage system is used), one or more driver-facing recommendations for target velocity, one or more vehicle-facing recommendations for target velocity, etc.

It should be appreciated that aspects of the present disclosure are not limited to using any particular model category or set of model categories, or to arranging model categories in any particular manner. For instance, in some embodiments, the model category 605 may receive an input directly from a model category comprising environment models, and/or an input directly from a model category comprising thermal models.

In some embodiments, model selection may be performed in parallel at a remote energy storage management system and a local energy storage management system (e.g., the illustrative remote energy storage management system 150 and the illustrative local energy storage management system 160 in the example of FIG. 1B). The inventors have recognized and appreciated that a remote energy storage management system may have more computational resources (e.g., memory, processing cycles, etc.) and/or access to more data (e.g., historical data, data from multiple energy applications, etc.). Therefore, a remote energy storage management system may be able to explore larger model categories, and therefore discover more accurate estimation models and/or energy management strategies with better performance.

For instance, for a given model category, a remote energy storage management system may analyze a large number of models, which may be based on different mathematical modeling approaches, and/or may use different approximation techniques. By contrast, for the same model category, a local energy storage management system may analyze a small number of models, such as estimation models that are deemed accurate by the remote energy storage management system, and/or energy management strategies that are deemed well performing by the remote energy storage management system. These local models may be replaced through over-the-air updates, which may be regularly scheduled and/or triggered by context changes.

Additionally, or alternatively, a remote energy storage management system may use a larger exploration parameter E than a local energy storage management system. Thus, the local energy storage management system may focus more on quickly adapting to changing conditions (e.g., traffic, weather, driver requests, etc.), while the remote energy storage management system may devote more computational resources to exploring different models. In this manner, the remote energy storage management system may be able to identify accurate estimation models for use by the local energy storage management system in comparing different energy management strategies, so that an energy management strategy selected by the local energy storage management system may lead to actual performance enhancement. However, it should be appreciated that aspects of the present disclosure are not limited to using any particular exploration parameter or combination of exploration parameters, or any exploration parameter at all.

The inventors have recognized and appreciated that it may be beneficial to have multiple (albeit a small number of) models in a model category used by a local energy storage management system. For instance, this may allow the local energy storage management system to switch to a different model if a currently deployed model is not satisfactory, without triggering an immediate over-the-air update. However, it should be appreciated that aspects of the present disclosure are not limited to having multiple models in a model category used by a local energy storage management system.

In some embodiments, historical data may be segmented prior to being used for selection of models. For instance, a model category may have an associated set of one or more attribute values. As an example, a model category for velocity profile may be tagged with a certain geographic area, a certain day of week, a certain time of day, etc., based on an assumption that traffic conditions tend to have a recurring pattern. These attribute values may be used to filter historical data, and the filtered data may in turn be used to select a velocity profile model from the model category.

Additionally, or alternatively, a model category for velocity profile may be tagged with one or more attribute values indicative of driving style. For instance, drivers may be classified based on how aggressively they accelerate and/or brake (e.g., average, aggressive, conservative, etc.). Historical data may then be filtered according to classification labels.

In some embodiments, historical data may be segmented based on multiple criteria, such as geographical area, time of day, time of week, time of year, weather condition, road surface, driver behavior, etc. However, it should be appreciated that aspects of the present disclosure are not limited to segmenting data in any particular manner, or at all.

In some embodiments, biometric identification (e.g., facial recognition, fingerprint recognition, etc.) may be used to distinguish data from different individuals driving a same vehicle (e.g., members of a same household, commercial drivers working in shifts, etc.). This may improve effectiveness of driver classification.

In some embodiments, live traffic data may be used to provide more accurate input to a model, and/or more accurate context for selecting a model from a model category. For instance, live traffic data may be obtained from public traffic monitoring systems and/or private traffic data providers.

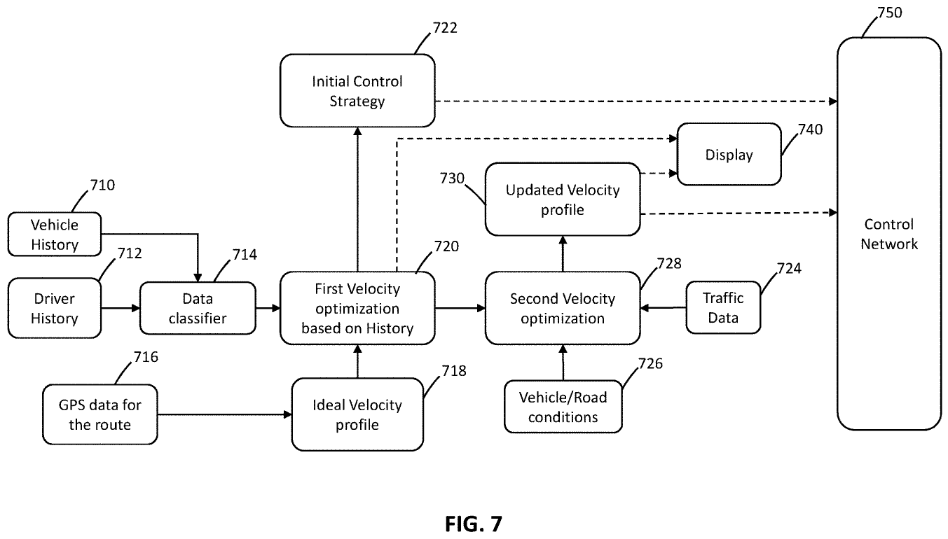

In some embodiments, one or more velocity profiles for a travel path of a vehicle are determined, for example, based on historical data and/or real-time data received by the system during operation of the vehicle. FIG. 7 illustrates a process 700 for determining a velocity profile in accordance with some embodiments. In some implementations, determining a velocity profile (also called “velocity optimization” herein) may be performed at multiple points in time. An initial velocity profile may be determined before the vehicle is set in motion or shortly thereafter. An updated velocity profile may be determined during transit of the vehicle along the travel path based, at least in part, on data that is received by the system during operation of the vehicle.

As shown in FIG. 7, a first velocity optimization process 720 receives as input history data including, but not limited to, vehicle history data 710 and driver history data 712. Data classifier 714 may classify the vehicle history data 710 and/or the driver history data 712 using one or more classification models or schema. For example, driver history data 712 may be analyzed by data classifier 714 to determine the type of driver (e.g., cautious driver, fast driver, etc.). In addition to history data, the first velocity optimization process also receives as input an ideal velocity profile 718 determined based, at least in part, on mapping data (e.g., GPS data) 716 determined for a route along the travel path. In some embodiments, based on a destination set by the driver, the ideal velocity profile 718 may be determined by dividing the total travel path into segments based, for example, on turns in the travel path. For example, a straight line path between each turn can be considered as one section of the travel path and the turn itself can be considered as another section of the travel path. A velocity limit for each of the segments of the travel path may be determined, for example, based on the GPS data 716 and other sources of information including, but not limited to, stops and signals that the vehicle may encounter along the segment. In one implementation, the velocity for a straight line segment of the travel path between turns can be optimized using lower and upper speed limits for the segment, distance to travel along the segment, vehicle weight, driving behavior information (e.g., from data classifier 714), and any other suitable information (e.g., vehicle dynamics parameters). The first velocity optimization process 720 may use this information to determine a velocity profile that, for example, minimizes total required power by the vehicle along the plurality of segments. It should be appreciated that the first velocity optimization process may use one or more other metrics (e.g. minimization of thermal loads, etc.) to perform optimization.

The first velocity profile output from the velocity optimization process may optionally be provided to a display 740 (e.g., on the vehicle dashboard or using a heads-up-display projected onto the vehicle windshield) to guide the driver during operation of the vehicle along the travel path. Additionally, or alternatively, the first velocity profile output from the velocity optimization process 740 may be provided to a controller configured to generate an initial energy management strategy for controlling operation of the vehicle (e.g., to provide speed targets to the vehicle's adaptive cruise control system as the vehicle travels along the segments of the travel path. In addition to the velocity profile, it should be appreciated that the initial energy management strategy 722 may be generated based, at least in part, on other information (e.g., expected power demand for the vehicle, an optimized set of energy management strategies, etc.). The initial energy management strategy 722 may be provided to control network 750 to control one or more operations of the vehicle along the travel path.

As shown, some embodiments include a second velocity optimization process 728 that outputs an updated velocity profile 730 based on data received by the system as the vehicle is traveling along the travel path to the destination. For example, traffic data 724 (e.g., current traffic conditions, accident information, construction information) and vehicle/road conditions 726 may be provided as input to the second velocity optimization process 728, and this information may be processed in real-time to adjust the velocity profile determined using the first velocity optimization process 720. In this way, if one or more of the input conditions are different from what was anticipated when generating the velocity profile output by the first velocity optimization process, system is configured to adapt to the changes in conditions, for example, by taking the vehicle speed a current moment in time as the starting point, to develop an updated velocity profile 730. The updated velocity profile 730 may be used to update display 740 and/or may be provided to control network 750 to update an energy management strategy used by the vehicle to control one or more operations of the vehicle along the travel path. In some embodiments, a driving behavior factor, used, for example, in the first velocity optimization process 720 and/or the second velocity optimization process 728 may be calculated based on the weighted average difference between the ideal velocity and the actual velocity of the vehicle over period of time (e.g., one week, one month, one year) of use of the vehicle.

It should be appreciated that for autonomous or unmanned vehicles, velocity profile 730 may also be sourced directly from one or more of the onboard controls of the vehicle, which would determine the velocity profile for future instances without human intervention. Such a velocity profile may accommodate any or all of the inputs traffic data 724, vehicle/road conditions 726, vehicle history 710, and GPS Data for the route 716, which would otherwise be used to forecast the velocity profile for a given driver or vehicle

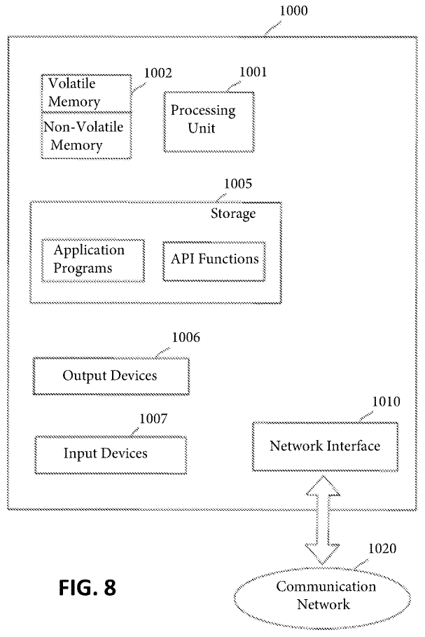

FIG. 8 shows, schematically, an illustrative computer 1000 on which any aspect of the present disclosure may be implemented. In the embodiment shown in FIG. 8, the computer 1000 includes a processing unit 1001 having one or more computer hardware processors and one or more articles of manufacture that comprise non-transitory computer-readable storage media (e.g., system memory 1002) that may include, for example, volatile and/or non-volatile memory. The memory 1002 may store one or more instructions to program the processing unit 1001 to perform any of the functions described herein. The computer 1000 may also include other types of non-transitory computer-readable media, such as storage 1005 (e.g., one or more disk drives) in addition to the system memory 1002. The storage 1005 may also store one or more application programs and/or external components used by application programs (e.g., software libraries), which may be loaded into the memory 1002. To perform any of the functionality described herein, processing unit 1001 may execute one or more processor-executable instructions stored in the one or more non-transitory computer-readable storage media (e.g., memory 1002, storage 1005), which may serve as non-transitory computer-readable storage media storing processor-executable instructions for execution by the processing unit 1001.

The computer 1000 may have one or more input devices and/or output devices, such as devices 1006 and 1007 illustrated in FIG. 8. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 8, the computer 1000 may also comprise one or more network interfaces (e.g., the network interface 10010) to enable communication via various networks (e.g., the network 10020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

1. The system of claim 20, wherein
the at least one processor is further programmed to
for each candidate model of a plurality of candidate models, determine a reward for using the candidate model in a context, wherein the context comprises a value of a feature selected from a group consisting of:
a feature relating to an environment in which the energy application is operating;
a feature relating to the energy application; and
a feature relating to one or more energy storage devices associated with the energy application; and
select a model from the plurality of candidate models, based at least in part on the respective rewards for using the candidate models in the context.

2. The system of claim 1, wherein:
the context comprises a current context;
the at least one processor is programmed to select a model from the plurality of candidate models in response to detecting a change from a prior context to the current context during operation of the energy application; and
the at least one processor is further programmed to deploy the selected model for the energy application in the current context.

3. The system of claim 1, wherein:
selecting a model from the plurality of candidate models comprises:
with a selected probability ∈:
select a model from the plurality of candidate models uniformly at random; and
with probability 1−∈:
select a model from the plurality of candidate models that has a highest reward with respect to the context.

4. The system of claim 1, wherein:
the reward for using a candidate model in the context is based on data collected from previously deploying the candidate model for the energy application in that context.

5. The system of claim 1, wherein:
the reward for using a candidate model in the context is based on data collected from deploying the candidate model for a plurality of energy applications in that context.

6. The system of claim 1, wherein:
the reward for using a candidate model in the context is based on data collected from performing simulation with the candidate model in that context.

7. The system of claim 1, wherein:
each candidate model of the plurality of candidate models belongs to a model category;
each candidate model of the plurality of candidate models has previously been deployed in the context; and
the at least one processor is further programmed to:
determine whether the model category comprises one or more candidate models that have not been deployed in the context; and
in response to determining that the model category comprises one or more candidate models that have not been deployed in the context, select a model from the one or more candidate models that have not been deployed in the context; and
the at least one processor is programmed to select a model from the plurality of candidate models, which have previously been deployed in the context, in response to determining that the model category does not comprise any candidate model that has not been deployed in the context.

8. The system of claim 1, wherein:
the at least one processor comprises a local processor associated with the energy application;
the plurality of candidate models comprises a first plurality of candidate models;
the local processor is programmed to:
determine a reward for each candidate model of the first plurality of candidate models; and
select a model from the first plurality of candidate models, based at least in part on the respective rewards;
the at least one processor further comprises a remote processor associated with a plurality of energy applications;
the remote processor is programmed to:
determine a reward for each candidate model of a second plurality of candidate models;
select a model from the second plurality of candidate models, based at least in part on the respective rewards; and
transmit, to the local processor, an indication of the model selected by the remote processor.

9. The system of claim 1, wherein:
the first plurality of candidate models, which is used by the local processor, is a subset of the second plurality of candidate models, which is used by the remote processor.

10. The system of claim 1, wherein:
each candidate model of the plurality of candidate models comprises an energy management strategy that maps one or more inputs to a power distribution among the one or more energy storage devices associated with the energy application.

11. The system of claim 10, wherein:
the plurality of candidate models comprises a first plurality of candidate models;
the context comprises a first context;
the feature comprises a first feature;
the selected model comprises the first machine learning model; and
the at least one processor is further programmed to:
for each candidate model of a second plurality of candidate models, determine a reward for using the candidate model in a second context, wherein the second context comprises a value of a second feature different from the first feature;
select a model from the second plurality of candidate models, based at least in part on the respective rewards for using the candidate models in the second context;
the model selected from the second plurality of candidate models comprises the second machine learning model;
for each candidate model of the second plurality of candidate models:
the candidate model comprises an estimation model that maps one or more inputs to an estimated value of the parameter; and
the reward for using the candidate model in the second context is based, at least in part, on accuracy of the estimation model when deployed in the second context.

12-13. (canceled)

14. The system of claim 1, wherein:
each candidate model of the plurality of candidate models comprises:
an energy storage device model that maps one or more inputs to an output relating to an energy storage device associated with the energy application;
an energy application model that maps one or more inputs to an output relating to the energy application; or
an environment model that maps one or more inputs to an output relating to the environment in which the energy application is operating.

15-16. (canceled)

17. The system of claim 1, wherein:
the energy application comprises an electric vehicle or an electric grid.

18-19. (canceled)

20. A system, comprising:
at least one computer processor; and
at least one computer-readable storage medium having encoded thereon instructions that, when executed, program the at least one processor to:
estimate a value of a parameter for an energy application using a plurality of machine learning models including a first machine learning model and a second machine learning model, wherein
the second machine learning model is configured to receive as input, at least one output of the first machine learning model, and
the value of the parameter is estimated, at least in part, based on an output of the second machine learning model.

21-22. (canceled)

23. The system of claim 20, wherein
the plurality of machine learning models further includes a third machine learning model and a fourth machine learning model;
the second machine learning model is further configured to receive as input, at least one output of the third machine learning model and at least one output of the fourth machine learning model;
the first machine learning model is trained to output an estimated state of charge of an energy storage device associated with the energy application;
the third machine learning model is trained to output an estimated velocity profile associated with the energy application;
the fourth machine learning model is trained to output an estimated climate control power demand associated with the energy application; and
the second machine learning model is trained to output a total power demand for the energy application based, at least in part, on the estimated state of charge, the estimated velocity profile, and the estimated climate control power demand provided as input to the second machine learning model.

24-29. (canceled)

30. A computer-implemented method, comprising:
estimating, by at least one computer processor, a value of a parameter for an energy application using a plurality of machine learning models including a first machine learning model and a second machine learning model, wherein
the second machine learning model is configured to receive as input, at least one output of the first machine learning model, and
the value of the parameter is estimated, at least in part, based on an output of the second machine learning model.

31. (canceled)

32. The computer-implemented method of claim 30, wherein
the plurality of machine learning models further includes a third machine learning model and a fourth machine learning model;
the second machine learning model is further configured to receive as input, at least one output of the third machine learning model and at least one output of the fourth machine learning model;
the first machine learning model is trained to output an estimated state of charge of an energy storage device associated with the energy application;
the third machine learning model is trained to output an estimated velocity profile associated with the energy application;
the fourth machine learning model is trained to output an estimated climate control power demand associated with the energy application; and
the second machine learning model is trained to output a total power demand for the energy application based, at least in part, on the estimated state of charge, the estimated velocity profile, and the estimated climate control power demand provided as input to the second machine learning model.

33. The computer-implemented method of claim 30, further comprising:
for each candidate model of a plurality of candidate models, determining a reward for using the candidate model in a context, wherein the context comprises a value of a feature selected from a group consisting of:
a feature relating to an environment in which the energy application is operating;
a feature relating to the energy application; and
a feature relating to one or more energy storage devices associated with the energy application; and
selecting a model from the plurality of candidate models, based at least in part on the respective rewards for using the candidate models in the context.

34. At least one non-transitory computer-readable medium having encoded thereon instructions which, when executed, cause at least one computer processor to perform a method, the method comprising:
estimating a value of a parameter for an energy application using a plurality of machine learning models including a first machine learning model and a second machine learning model, wherein
the second machine learning model is configured to receive as input, at least one output of the first machine learning model, and
the value of the parameter is estimated, at least in part, based on an output of the second machine learning model.

35. The at least one non-transitory computer-readable medium of claim 34, wherein the method further comprises:
for each candidate model of a plurality of candidate models, determining a reward for using the candidate model in a context, wherein the context comprises a value of a feature selected from a group consisting of:
a feature relating to an environment in which the energy application is operating;
a feature relating to the energy application; and
a feature relating to one or more energy storage devices associated with the energy application; and
selecting a model from the plurality of candidate models, based at least in part on the respective rewards for using the candidate models in the context.
